(19) United States
(12) Patent Application Publication
(10) Pub. No.: US 2011/0305250 A1
(43) Pub. Date: Dec. 15, 2011

(54) WAVELENGTH BEAM COMBINING BASED PULSED LASERS

(75) Inventors: Bien Chann, Merrimack, NH (US); Robin Huang, N. Billerica, MA (US)

(73) Assignee: TERADIODE, INC., Littleton, MA (US)

(21) Appl. No.: 13/041,035

(22) Filed: Mar. 4, 2011

Related U.S. Application Data
(60) Provisional application No. 61/310,777, filed on Mar. 5, 2010.
(60) Provisional application No. 61/310,781, filed on Mar. 5, 2010.
(60) Provisional application No. 61/417,394, filed on Nov. 26, 2010.

(51) Int. Cl. H01S 3/10

(52) U.S. Cl. 372/6; 372/26

(57) ABSTRACT

A system for producing a laser pulse includes a laser driver capable of direct modulation of a laser source comprising a plurality of lasers, and a wavelength beam combining cavity, comprising the directly modulated laser source, for producing a wavelength beam combining output of light from the plurality of lasers. The wavelength beam combining cavity may comprise a fast axis wavelength beam combining cavity. The laser source may comprise a multidimensional array of diode lasers disposed in a stack spatially interleaved or optically aligned. Each of the plurality of diode lasers may produce a distinct wavelength.

### CROSS-REFERENCE TO RELATED APPLICATIONS

This application claims the benefit of the following provisional applications, each of which is hereby incorporated by reference in its entirety:

U.S. Ser. No. 61/310,777 filed Mar. 5, 2010; U.S. Ser. No. 61/310,781 filed Mar. 5, 2010, and U.S. Ser. No. 61/417,394 filed Nov. 26, 2010.

This application is also related to the following U.S. patent matters each of which is incorporated by reference herein in its entirety: issued U.S. Pat. No. 6,192,062 and U.S. Pat. No. 6,208,679; published application US 2010/0110556; and patent application U.S. Ser. No. 12/788,579.

### BACKGROUND OF THE INVENTION

1. Field

The methods and systems described herein generally relate to applications of wavelength beam combining-enabled lasers.

2. Description of the Related Art

In particular the methods and systems described herein relate to applications of wavelength beam combining for pulsed lasers and for pump lasers.

### SUMMARY OF THE INVENTION

Lasers have numerous industrial, scientific, and defense applications. Industrial applications include metal cutting, spot welding, seam welding, drilling, fine cutting, and marking. Scientific applications include laser-guide stars for astronomy, gravitational wave detection, laser cooling and trapping, and laser-based particle accelerator. Defense applications include the laser-based weapon, the laser-induced spark, and LIDAR.

Example lasers that are applicable as described above include high average and high peak power fiber lasers and amplifiers, high average and peak power eye-safe Erbium-doped (Er-doped) fiber lasers and amplifiers, quasi-continuous wave (QCW) or pulsed or long-pulsed operation of industrial lasers, short pulsed (pulse widths of a few ns to hundreds of ns) operation of industrial lasers, and the like.

When wavelength beam combining is applied to any of the lasers described herein, including the lasers that are applicable as described above many of the relevant factors that impact laser utilization can be substantially improved. Aspects such as power output can be significantly increased, brightness can be substantially improved, cost can be dramatically reduced, thermal and fiber-related optics challenges can be readily overcome or mitigated to the point of insignificance, overall size can be reduced, and the like. Results of these and other factors may be improved by two or more orders of magnitude with wavelength beam combining.

The laser methods and systems described herein relate to WBC lasers that can be formed using any of a number of WBC designs described herein or in related matters referenced herein.

This application discloses, among other things, the use of WBC lasers to pump (excite) another laser, generally a fiber laser or a solid-state laser. The WBC laser provides superior power and/or brightness compared to non-WBC pumps. The superior pump brightness enables a low numerical aperture (NA), which leads to improved fiber laser design, performance, and reliability, especially at powers >1 kW. Examples of WBC pump lasers for fiber lasers are 976 nm pumps for Yb fiber, 1480 nm and 1532 nm pumps for Er fiber and 793 nm pumps for thulium fiber lasers. These WBC pumps are generally fiber coupled, and can be operated in continuous wave (CW) mode or in a variety of pulsed modes, including arbitrary waveforms. WBC pumps are disclosed that benefit single-frequency fiber lasers and amplifiers, and that provide at least 10× better pump-wavelength stability compared to conventional pumps. WBC pumping is also disclosed to pump a T/WDM amplifier, such as one described in co-pending U.S. application Ser. No. 12/788,579 to generate ultra-high peak power (scalable to multi MW). Applications of this latter device include a source for EUV lithography.

WBC lasers are disclosed that operate in a variety of pulsed modes. Quasi continuous wave (QCW) WBC lasers are disclosed for applications where the pulse width is <10 ms, and power can be a multiple (e.g. 4×) of the CW power. Short-pulse WBC lasers in which the laser gain elements are operated in a gain-switched mode for generating nano-second length pulses at power levels much higher than CW (e.g., 18 times higher). Any of the pulsed modes can have a variety of waveforms and/or pulse repetition rates. It is further disclosed that by using a multi-dimensional array of laser elements, and appropriate electrical drivers, a WBC laser can emit a desired arbitrary waveform. These pulsed WBC lasers are disclosed for applications including cutting (e.g., of metals), spot welding, seam welding, drilling, other material processing applications, and the like.

A laser, such as a laser described in the following general description may be used in association with embodiments of the innovations described herein.

Lasers may generally be defined as devices that generate visible or invisible light through stimulated emission of light. “Laser” originally was an acronym for “Light Amplification by Stimulated Emission of Radiation”, coined in 1957 by the laser pioneer Gordon Gould, but is generally now mostly used for devices that produce light using the laser principle.

Lasers generally have properties that make them useful in a variety of applications. Laser properties may include: emitting light as a laser beam which can propagate over long lengths without much divergence and can be focused to very small spots; a very narrow bandwidth as compared to most other light sources which produce a very broad spectrum; light can be emitted continuously, or in short bursts (pulses) that may be as short as a few femto-seconds.

Lasers may come in a variety of types. Common laser types include semiconductor lasers, solid-state lasers, fiber lasers, and gas lasers.

Semiconductor lasers (mostly laser diodes) may be electrically or optically pumped and generally efficiently generate very high output powers often at the expense of poor beam quality. Semiconductor lasers may produce low power with good spatial properties for application in CD and DVD players. Yet other semiconductor lasers may be suitable for producing high pulse rate, low power pulses (e.g. for telecom applications). Special types of semiconductor lasers include quantum cascade lasers (for mid-infrared light) and surface-emitting semiconductor lasers (VCSELs and VECSELs), the latter also being suitable for pulse generation with high powers. Semiconductor lasers are further described elsewhere herein under the heading “LASER DIODE”

Solid-state lasers may be based on ion-doped crystals or glasses (e.g. doped insulator lasers) and may be pumped with discharge lamps or laser diodes for generating high output power. Alternatively solid-state lasers may produce low power output with very high beam quality, spectral purity and/or stability (e.g. for measurement purposes). Some solid-state lasers may produce ultra-short pulses with picosecond or femtosecond durations. Common gain media for use with solid state lasers include: Nd:YAG, Nd:YVO4, Nd:YLF, Nd:glass, Yb:YAG, Yb:glass, Ti:sapphire, Cr:YAG and Cr:LiSAF.

Fiber lasers may be based on optical glass fibers which are doped with some laser-active ions in the fiber core. Fiber lasers can achieve extremely high output powers (up to kilowatts) with high beam quality have limited wavelength-tuning operation. Narrow line width operation and the like may also be supported by fiber lasers.

Gas lasers may include helium-neon lasers, CO₂ lasers, argon ion lasers, and the like may be based on gases which are typically excited with electrical discharges. Frequently used gases include CO₂, argon, krypton, and gas mixtures such as helium-neon. In addition, excimer lasers may be based on any of ArF, KrF, XeF, and F2. Other less common laser types include: chemical and nuclear pumped lasers, free electron lasers, and X-ray lasers.

A laser diode, such as a laser diode described in the following general description may be used in association with embodiments of the innovations described herein and in the exhibits referenced herein.

A laser diode is generally based around a simple diode structure that supports the emission of photons (light). However, to improve efficiency, power, beam quality, brightness, tunability, and the like, this simple structure is generally modified to provide a variety of many practical types of laser diodes. Laser diode types include small edge-emitting varieties that generate from a few milliwatts up to roughly half a watt of output power in a beam with high beam quality. Structural types of diode lasers include double hetero-structure lasers that include a layer of low bandgap material sandwiched between two high bandgap layers; quantum well lasers that include a very thin middle layer (quantum well layer) resulting in high efficiency and quantization of the laser's energy; multiple quantum well lasers that include more than one quantum well layer improve gain characteristics; quantum wire or quantum sea (dots) lasers replace the middle layer with a wire or dots that produce higher efficiency quantum well lasers; quantum cascade lasers that enable laser action at relatively long wavelengths which can be tuned by altering the thickness of the quantum layer; separate confinement heterostructure lasers, which are the most common commercial laser diode and include another two layers above and below the quantum well layer to efficiently confine the light produced; distributed feedback lasers, which are commonly used in demanding optical communication applications and include an integrated diffraction grating that facilitates generating a stable wavelength set during manufacturing by reflecting a single wavelength back to the gain region; vertical-cavity surface-emitting laser (VCSEL), which have a different structure that other laser diodes in that light is emitted from its surface rather than from its edge; vertical-external-cavity surface-emitting-laser (VECSELs) and external-cavity diode lasers, which are tunable lasers that use mainly double heterostructures diodes and include gratings or multiple-prism grating configurations. External-cavity diode lasers are often wavelength-tunable and exhibit a small emission line width. Laser diode types also include a variety of high power diode-based lasers including: broad area lasers that are characterized by multi-mode diodes with 1×100 um oblong output facets and generally have poor beam quality but generate a few watts of power; tapered lasers that are characterized by astigmatic mode diodes with 1×100 um tapered output facets that exhibit improved beam quality and brightness when compared to broad area lasers; ridge waveguide lasers that are characterized by elliptical mode diodes with 1×4 um oval output facets; and slab-coupled optical waveguide lasers (SCOWL) that are characterized by circular mode diodes with 4×4 um and larger output facets and can generate watt-level output in a diffraction-limited beam with nearly a circular profile. There are other types of diode lasers reported in addition to those described above.

Laser diode arrays, bars and/or stacks, such as those described in the following general description may be used in association with embodiments of the innovations described herein and in the exhibits referenced herein.

Laser diodes may be packaged individually or in groups, generally in one-dimensional rows/arrays (diode bar) or two dimensional arrays (diode-bar stack). A diode array stack is generally a vertical stack of diode bars. Laser diode bars or arrays generally achieve substantially higher power, and cost effectiveness than an equivalent single broad area diode. High-power diode bars generally contain an array of broad-area emitters, generating tens of watts with relatively poor beam quality and despite the higher power the brightness is often lower than that of a broad area laser diode. High-power diode bars can be stacked to produce high-power stacked diode bars for generation of extremely high powers of hundreds or thousands of watts. Laser diode arrays can be configured to emit a beam into free space or into a fiber. Fiber-coupled diode-laser arrays can be conveniently used as a pumping source for fiber lasers and fiber amplifiers.

A diode-laser bar is a type of semiconductor laser containing a one-dimensional array of broad-area emitters or alternatively containing sub arrays containing 10-20 narrow stripe emitters. A broad-area diode bar typically contains 19-49 emitters, each being on the order of e.g. 1×100 μm wide. The beam quality along the 1-μm dimension or fast-axis is typically diffraction-limited. The beam quality along the 100-μm dimension or slow-axis or array dimension is typically many times diffraction-limited. Typically, a diode bar for commercial applications has a laser resonator length of the order of 1 to 4 mm, is about 10 mm wide and generates tens of watts of output power. Most diode bars operate in the wavelength region from 780 to 1070 nm, with the wavelengths of 808 nm (for pumping neodymium lasers) and 940 nm (for pumping Yb:YAG) being most prominent. The wavelength range of 915-976 nm is used for pumping erbium-doped or ytterbium-doped high-power fiber lasers and amplifiers.

A property of diode bars that are usually addressed is the output spatial beam profile. For most applications beam conditioning optics are needed. Significant efforts are therefore often required for conditioning the output of a diode bar or diode stack. Conditioning techniques include using aspherical lenses for collimating the beams while preserving the beam quality. Microoptic fast axis collimators are used to collimate the output beam along the fast-axis. Array of aspherical cylindrical lenses are often used for collimation of each laser element along the array or slow-axis. To achieve beams with approximately circular beam waist a special beam shaper for symmetrization of the beam quality of each diode bar or array can be applied. A degrading property of diode bars is the “smile”—a slight bend of the planar nature of the connected emitters. Smile errors can have detrimental effects on the ability to focus beams from diode bars. Another degrading property is collimation error of the slow and fast-axis. For example, a twisting of the fast-axis collimation lens results in an effective smile. This has detrimental effects on the ability to focus. In stack “pointing” error of each bar is the most dominant effect. Pointing error is a collimation error. This is the result of the array or bar that is offset from the fast-axis lens. An offset of 1 μm is the same as the whole array having a smile of 1 μm.

Diode bars and diode arrays overcome limitations of very broad single emitters, such as amplified spontaneous emission or parasitic lasing in the transverse direction or filament formation. Diode arrays can also be operated with a more stable mode profile, because each emitter produces its own beam. Techniques which exploit some degree of coherent coupling of neighbored emitters can result in better beam quality. Such techniques may be included in the fabrication of the diode bars while others may involve external cavities. Another benefit of diode arrays is that the array geometry makes diode bars and arrays very suitable for coherent or spectral beam combining to obtain a much higher beam quality.

In addition to raw bar or array offerings, diode arrays are available in fiber-coupled form because this often makes it much easier to utilize each emitter's output and to mount the diode bars so that cooling of the diodes occurs some distance from the place where the light is used. Usually, the light is coupled into a single multimode fiber using either a simple fast-axis collimator and no beam conditioning in the slow-axis direction, or a more complex beam shaper to preserve the brightness better. It is also possible to launch the beamlets from the emitters into a fiber bundle (with one fiber per emitter).

Emission bandwidth of a diode bar or diode array is an important consideration for some applications. Optical feedback (e.g. from volume Bragg grating) can significantly improve wavelength tolerance and emission bandwidth. In addition, bandwidth and exact center wavelength can also be important for spectral beam combining.

A diode stack is simply an arrangement of multiple diode bars that can deliver very high output power. Also called diode laser stack, multi-bar module, or two-dimensional laser array, the most common diode stack arrangement is that of a vertical stack which effectively comprises a two-dimensional array of edge emitters. Such a stack can be fabricated by attaching diode bars to thin heat sinks and stacking these assemblies so as to obtain a periodic array of diode bars and heat sinks. There are also horizontal diode stacks, and two-dimensional stacks.

For the high beam quality, the diode bars generally should be as close to each other as possible. On the other hand, efficient cooling requires some minimum thickness of the heat sinks mounted between the bars. This tradeoff of diode bar spacing results in beam quality of a diode stack in the vertical direction (and subsequently its brightness) is much lower than that of a single diode bar. There are, however, several techniques for significantly mitigating this problem, e.g. by spatial interleaving of the outputs of different diode stacks, by polarization coupling, or by wavelength multiplexing. Various types of high-power beam shapers and related devices have been developed for such purposes. Diode stacks can provide extremely high output powers (e.g. hundreds or thousands of watts).

There are also horizontal diode stacks, where the diode bars are arranged side-by-side, leading to a long linear array of emitters. Such an arrangement is more easily cooled due to the naturally convective cooling that occurs between the vertically oriented diode bars, and may thus also allow for a higher output power per emitter. Generally, the number of diode bars in a horizontal stack (and thus the total output power) is more limited than in a vertical stack.

Diode bars and diode stacks can achieve very high power without significant cooling challenges by applying quasi-continuous-wave operation that includes generate pulses of a few hundred microseconds duration and a pulse repetition rate of some tens of hertz.

Technologies and embodiments of wavelength beam combining, such as those described in the following general description may be used in association with embodiments of the innovations described herein and in the exhibits referenced herein.

As the light emitted by a laser diode is linearly polarized, it is possible to combine the outputs of two diodes with a polarizing beam splitter, so that a beam with twice the power of a single diode but the same beam quality can be obtained (this is often referred to as polarization multiplexing). Alternatively, it is possible to spectrally combine the beams of laser diodes with slightly different wavelengths using dichroic mirrors. More systematic approaches of beam combining allow combining a larger numbers of emitters with a good output beam quality.

Beam combining is generally used for power scaling of laser sources by combining the outputs of multiple devices. The principle of beam combining can essentially be described as combining the outputs of multiple laser sources, often in the form of a laser array to obtain a single output beam. The application of a scalable beam-combining technology can produce a power-scalable laser source, even if the single lasers contributing to the combined beam are not scalable. Beam combining generally targets multiplying output power while preserving beam quality so that the brightness is increased (nearly) as much as the output power.

While there may be many different approaches for beam combining with increased brightness, all can be grouped into one of three categories: coherent, polarization, and wavelength beam combining. Coherent beam combining works with beams which are mutually coherent. In a simple example monochromatic beams with the same optical frequency can be combined. However, some schemes of coherent beam combination are much more sophisticated and therefore work with emissions occurring over multiple frequencies, with the emission spectra of all emitters being the same.

Polarization beam combining combines two linearly polarized beams with a polarizer (e.g., a thin-film polarizer). Of course, this method is not repeatable, since it generates a non-polarized output. Therefore, the method does not allow power scaling in a strict sense. Each of these three techniques can be applied to various laser sources, e.g., based on laser diodes (particularly diode bars) and fiber amplifiers, but also to high-power solid-state bulk lasers and VECSELs.

Wavelength beam combining (herein WBC) (also called spectral beam combining or incoherent beam combining) does not require mutual coherence because it employs emitters with non-overlapping optical spectra whose beams are fed into a wavelength-sensitive beam combiner, such as a prism, a diffraction grating, a dichroic minor, a volume Bragg grating, and the like to produce a wavelength combined beam. WBC methods and systems that may be used herein are described herein and in greater detail in U.S. Pat. No. 6,192,062, U.S. Pat. No. 6,208,679, and U.S. 2010/0110556A1, the entirety of each is incorporated herein. Wavelength beam combining successfully achieves superior beam combining without any significant loss of beam quality. Wavelength beam combining is also more reliable than a single high power laser diode because the failure of one emitter simply reduces the output power accordingly.

The general principle of wavelength beam combining is to generate several laser diode beams with non-overlapping optical spectra and combine them at a wavelength-sensitive beam combiner so that subsequently all of the beams propagate in the same direction.

To combine many diode lasers and achieve good beam quality, laser diodes that are combined must each have an emission bandwidth which is only a small fraction of the gain bandwidth. Beam quality during wavelength beam combining is further affected by the angular dispersion of the beam combiner. Beam combiners with sufficiently strong dispersion and wavelength stable laser diodes go a long way toward achieving good beam quality during wavelength beam combining. Techniques for tuning laser diode wavelengths to facilitate wavelength beam combining, range from independently tuning each laser to a predetermined wavelength, to automatically adjusting each laser diode beam wavelength based on its spatial position relative to the combined beam path.

Wavelength beam combining may be used for power scaling. While a simple example of nearly unlimited power scaling would be to tile collimated beams from a large number of independently running adjacent lasers, even though the combined power increases in proportion to the number of lasers, the beam quality of the combined output decreases while the brightness will be at best only equivalent to a single laser. Typically the brightness of the system is much lower than a single element. Therefore one can see that power scaling methods which conserve the beam quality of the beam combining elements are highly desirable.

Wavelength beam combining may be applied to various types of laser diode configurations including diode bars, diode stacks, and the like. A diode bar is a one-dimensional array of broad area laser emitters that can be combined with various fiber and optical systems to produce one or more wavelength combined beams. Diode bars may include two to fifty or more laser emitters on one linear substrate. Diode stacks are essentially a two dimensional array of diode. Diode bars can be fabricated into diode stacks in vertical stacking or horizontal stacking arrangements.

In an aspect of the methods and systems described herein a short pulse laser system includes a short pulse laser source comprising a plurality of lasers, a wavelength beam combining cavity, comprising the laser source, for producing a wavelength beam combined output, and a coupling facility for coupling the wavelength beam combining output. The aspect may include a laser driver for modulating the laser source. In the aspect modulating the laser source includes laser gain switching. The laser driver may be capable of direct modulation control of the laser source. In the aspect, the short pulse laser source produces the light pulses using laser gain switching. Alternatively, the laser source may be a QCW laser or a CW laser operated in a gain-switched pulsed mode. Alternatively, the laser source is operated in a gain-switched pulsed mode. The wavelength beam combining cavity may comprise a fast axis wavelength beam combining cavity. In the aspect may be a fiber coupling facility or a free-space coupling facility. The coupling facility may include beam shaping optics or post resonator optics. The laser source may include a multidimensional array of diode lasers that may include a plurality of diode laser bars disposed in a stack. The diode bars in the stack may be spatially interleaved or optically aligned to form an optical stack. The wavelength beam combining output coupling may facilitate coupling to fiber in a 20-600 micron core diameter range. In the aspect, the laser source may be a QCW laser source that comprises a plurality of diode laser bars disposed in a stack that may be spatially interleaved or optically aligned.

In another aspect of the method and systems described herein a system for producing a laser pulse may include a laser driver capable of direct modulation of a laser source comprising a plurality of lasers and a wavelength beam combining cavity, comprising the directly modulated laser source, for producing a wavelength beam combining output of light from the plurality of lasers. In the aspect the wavelength beam combining cavity comprises a fast axis wavelength beam combining cavity. Alternatively, the laser source is a CW laser operated in a gain-switched pulsed mode. The laser source may be operated in a gain-switched pulsed mode, or it may include a multidimensional array of diode lasers that may include a plurality of diode laser bars disposed in a stack that may be spatially interleaved or optically aligned to form an optical stack. In this aspect, the plurality of lasers may include a plurality of distinct wavelength lasers. The laser source may be a QCW laser that may include a plurality of diode laser bars disposed in a stack that may be spatially interleaved or optically aligned. The system may include a laser driver for controlling the laser source that may be capable of direct modulation control of the laser source. Also, each of a portion of the plurality of lasers may receive a direct modulation signal at a distinct time. In the aspect, the system may further include waveform shaping optics or post resonator optics. Alternatively, the system may further include a coupling facility for coupling the wavelength beam combining output. The coupling facility may be a fiber coupling facility or a free-space coupling facility. The coupling facility may optionally include beam-shaping optics or post resonator optics. Also, the coupling facility may facilitate coupling to fiber in a 20-600 micron core diameter range. In the aspect, the laser driver is in communication with the laser source so that each of the plurality of lasers receives a distinct modulation. The distinct modulation of at least two of the plurality of lasers may be coordinated. Optionally, the distinct modulation produces a sequence of laser pulses from at least a portion of the plurality of lasers. Each pulse of the sequence of laser pulses may be offset by a predetermined amount of time. The offset may be selected to substantially maximize peak output power, substantially maximize average output power, or facilitate reducing thermal management of the laser source. The laser source in the system may comprise a plurality of diode laser bars disposed in a stack. Optionally, at least two of the diode bars in the stack may be modulated differently. Alternatively, at least two diodes in at least one of the diode bars may be modulated differently. In the aspect the driver may directly modulate a current applied to the laser source or pulse-width modulate the laser source.

In yet another aspect of the methods and systems described herein, a system for producing a laser pulse may include a laser driver capable of direct modulation of a laser source comprising a plurality of lasers, and a wavelength beam combining cavity, comprising the directly modulated laser source, for producing a wavelength beam combining output from light generated by the laser source. The wavelength beam combining cavity may comprise a fast axis wavelength beam combining cavity. The laser driver may be in communication with the laser source so that each of the plurality of lasers receives a distinct modulation. The distinct modulation of at least two of the plurality of lasers may be coordinated. In the aspect, the distinct modulation may produce a sequence of laser pulses from at least a portion of the plurality of lasers. Each pulse of the sequence of laser pulses may be offset by a predetermined amount of time. The offset may be selected to substantially maximize peak output power or to substantially maximize average output power. Alternatively, the offset may facilitate reducing thermal management of the laser source. In the aspect, the source may comprise a plurality of diode laser bars disposed in a stack. Optionally, at least two of the diode bars in the stack are modulated differently or at least two diodes in at least one of the diode bars are modulated differently. The driver may directly modulate a current applied to the laser source or it may pulse-width modulate the laser source.

In an aspect of the methods and systems described herein, a method of producing an arbitrary wavelength beam combining laser waveform may include directly modulating a multidimensional laser source that comprises a first plurality of lasers disposed along a first dimension that output nominally the same wavelength laser beams and a second plurality of lasers disposed along a second dimension that output substantially different wavelength laser beams and wavelength beam combining the laser beams along the first dimension and spatially overlapping the laser beams along the second dimension to produce a wavelength beam combined laser output. In the method, directly modulating may include providing a distinct modulation to distinct portions of the laser source. Alternatively, the distinct modulation of at least two of the first plurality of lasers may be coordinated. Yet in another alternative of the method, the distinct modulation produces a sequence of laser pulses from at least a portion of the first plurality of lasers. In this alternative each pulse of the sequence of laser pulses may be offset by a predetermined amount of time. The offset may alternatively be selected to substantially maximize peak output power or to substantially maximize average output power. Alternatively, the offset facilitates reducing thermal management of the laser source. In the method the laser source may comprise a plurality of diode laser bars disposed in a stack so that the diode bars are spatially interleaved or optically aligned. Also, at least two of the diode bars in the stack may be modulated differently or at least two diodes in at least one of the diode bars may be modulated differently. In the method, directly modulating may include modulating a current applied to the laser source or pulse-width modulating the laser source.

In another aspect of the methods and systems described herein a method of high peak power lasing may include amplifying a laser signal comprising a plurality of time division multiplexed individual wavelength beams, dispersing the laser signal to separate each of the plurality of wavelengths, and delaying each dispersed wavelength to align each dispersed wavelength to produce a laser output that comprises each of the plurality of wavelengths temporally and spatially overlapped. In this method, the laser signal may be sourced from a CW laser operated in a gain-switched pulsed mode, generated using a gain-switched pulsed mode, or sourced from a multidimensional array of diode lasers that may comprise a plurality of diode laser bars disposed in a stack so that the diode bars in the stack are spatially interleaved or optically aligned to form an optical stack. The laser signal may be sourced from a plurality of distinct wavelength lasers, from a QCW laser. The method may further include shaping the laser output using waveform shaping optics may include post resonator optics.

In another aspect of the methods and systems described herein a method of high power lasing may include receiving a plurality of laser signals each comprising a different wavelength, delaying each different wavelength, multiplexing the delayed different wavelengths onto a single laser fiber to produce an amplified time division multiplexed multi-wavelength signal, and producing a plurality of high laser power pulses that comprise each of the different wavelengths that are temporally and spatially overlapped. In the method, producing a plurality of high laser power pulses comprises passing the amplified time division multiplexed, multi-wavelength signal through a beam shaper comprising a plurality of gratings and a plurality of mirrors.

In another aspect of the methods and systems described herein a method of spatially and temporally aligning a time-division-multiplexed, multi-wavelength laser signal including dispersing the laser signal into spectral components with a first grating,

directing the spectral components in parallel beams with a second grating into a two-mirror beam shaper, delaying each spectral component uniquely through the beam shaper to cause the spectral components to temporally align and reflect toward the second grating, spatially combining the spectral components at the first grating with the second grating, and reflecting the temporally and spatially combined spectral components with a minor to produce a high pulsed power laser that outputs pulses consistent with the temporally and spatially combined spectral components.

In another aspect of the methods and systems described herein a high brightness laser may include a plurality of laser sources disposed in a plurality of arrays, a plurality of spherical lenses disposed between the plurality of arrays and a cylindrical lens, wherein each of the plurality of spherical lenses transmits light emitted from a different one of the plurality of arrays to the cylindrical lens, the cylindrical lens for transmitting light from the plurality of arrays to a spherical transform lens, the spherical transform lens for focusing the transmitted light onto a surface of a grating, and a telescope for receiving the focused light output from the grating and for further transmission to an output coupler.

In another aspect of the methods and systems described herein a method of producing high brightness laser light may include disposing a plurality of arrays of light sources to output a plurality of laser light beams onto a plurality of spherical lenses which direct the plurality of laser light beams toward a cylindrical lens that propagates the plurality of laser light beams to a spherical transform lens that focuses the plurality of laser light beams to an area of a grating wherein the focused light is propagated through a telescope to an output coupler. In the method the plurality of arrays of light sources include at least one multi-dimensional array of diode lasers.

In another aspect of the methods and systems described herein a method of direct diode pumping a fiber laser may include disposing a plurality of diode lasers in a wavelength beam combining cavity for generating a wavelength beam combining laser output, optically coupling the wavelength beam combining laser output to the gain medium of a fiber laser. In the method, the wavelength beam combining cavity comprises a fast axis wavelength beam combining cavity. Alternatively in the method, the plurality of diode lasers comprises a multidimensional array of diode lasers that may comprise a plurality of diode laser bars disposed in a stack. The diode bars in the stack may be spatially interleaved or optically aligned to form an optical stack. The plurality of diode lasers may include a plurality of distinct wavelength lasers. Alternatively, the method may include a laser driver for controlling the plurality of diode lasers. The laser driver may be capable of direct modulation control of the laser source. Also, each of a portion of the plurality of lasers may receive a direct modulation signal at a distinct time.

In another aspect of the methods and systems described herein a method of wavelength beam combining-based fiber laser pumping may include disposing a plurality of 976 nm-range diode lasers in a wavelength beam combining cavity for generating a wavelength beam combining laser signal with power of at least 1000 watts, and optically coupling the wavelength beam combining laser signal to the gain medium of a fiber laser. In the method the wavelength beam combining cavity may comprise a fast axis wavelength beam combining cavity. The wavelength beam combining may provide a pump source for a fiber laser power of at least 2000 W. Alternatively, the wavelength beam combining laser beam may have a spectral bandwidth in the 3 nm range. Yet alternatively, the wavelength beam combining pump may be scalable to output greater than 20,000 W power. Also, the wavelength beam combining laser beam fiber numerical aperture may be in the 0.1 range.

In another aspect of the methods and systems described herein a method of lasing with a Yb-based fiber laser capable of producing >1 KW with a single stage pump may include configuring a Yb-fiber as a laser source, and pumping the Yb-doped fiber with a single stage direct diode pump, wherein the single stage direct diode pump comprises a wavelength beam combining-based laser operating in the 976 nm range.

In another aspect of the methods and systems described herein a method of pumping a fiber laser may include disposing a first plurality of wavelength beam combining-based lasers proximal to a first end of a fiber laser, disposing a second plurality of wavelength beam combining-based lasers proximal to a second end of the fiber laser, and delivering optical energy from the first and second pluralities of wavelength beam combining-based lasers to a gain medium of the fiber laser to facilitate outputting increased power and energy from the fiber laser.

In another aspect of the methods and systems described herein a method of pumping a fiber laser with a plurality of pump lasers may comprise disposing at least one n:1 fiber combiner to facilitate pumping a lasing fiber with a plurality of wavelength beam combining-based lasers, wherein the at least one n:1 fiber combiner is disposed between a plurality of wavelength beam combining-based lasers and a gain medium of the lasing fiber for at least one end of the lasing fiber. In the method, a first n:1 fiber combiner delivers light from a first plurality of wavelength beam combining-based lasers to a first end of the lasing fiber and a second n:1 fiber combiner delivers light from a second plurality of wavelength beam combining-based lasers to a second end of the lasing fiber. In the method, the fiber laser is instead a fiber amplifier.

In another aspect of the methods and systems described herein a wavelength stabilized laser pump may comprise a wavelength beam combining-based direct diode laser adapted to deliver wavelength beam combined optical energy to a gain medium of a fiber laser to facilitate pumping the fiber laser without requiring temperature stabilization.

In another aspect of the methods and systems described herein a wavelength beam combining direct laser pump, comprising a wavelength beam combining-based direct diode laser adapted to deliver wavelength beam combined optical energy to a gain medium of a fiber laser. The pump laser may be adapted to facilitate pumping the fiber laser to produce increased output energy.

In another aspect of the methods and systems described herein a method of producing at least 500 W from an Er-doped fiber laser may comprise pumping the Er-doped fiber laser with a wavelength beam combining enabled direct diode lasers operating with a centered wavelength in the range of 1400 nm to 1599 nm. In the method, the centered wavelength is either 1480 nm or 1532 nm.

In another aspect of the methods and systems described herein a method of pumping a Thulium fiber laser may include disposing a wavelength beam combining cavity that includes a plurality of 793 nm-region center wavelength diode lasers for generating a wavelength beam combining laser output, and optically coupling the wavelength beam combining laser output to the gain medium of the Thulium fiber laser to facilitate pumping the Thulium fiber laser in the 793 nm range.

In another aspect of the methods and systems described herein a method of wavelength beam combining pumping a T/WDM single fiber amplifier may include disposing a wavelength beam combining cavity in an optical path of a plurality of diode lasers for generating a wavelength beam combining laser output and optically coupling the wavelength beam combining laser output to the gain medium of a waveform time-wavelength division multiplexed single fiber amplifier. The method may further include optically coupling pulsed seed lasers to the core of the single fiber amplifier; and combining a pulsed output of the single fiber amplifier by temporal and spatial overlap means. In the method, the temporal and spatial overlap means may include a pair of gratings disposed in the optical path of the pulsed output of the single fiber amplifier. Also, in the method, the pulsed output is scalable to produce multi-megawatt power.

In another aspect of the methods and systems described herein a laser pump for an all-glass fiber laser may include a wavelength beam combining laser adapted to deliver wavelength beam combined optical energy to a gain medium of an all-glass fiber laser. The all-glass fiber laser may be formed from double-clad fiber.

In another aspect of the methods and systems described herein an apparatus may include a wavelength combined high brightness pump coupled through a pump coupler to pump a fiber laser, the pump adapted to substantially reduce thermal loading of the pump coupler. The pump may be adapted to achieve coupler loss less than 0.1 dB. Alternatively, the pump may have a suitably low NA and delivery core diameter suitable for delivering greater than 100 W output power.

In another aspect of the methods and systems described herein an apparatus may include a fiber laser pumped by a wavelength combined high brightness pump that is adapted to enable use of substantially short, rare-earth doped lasing fiber, such that photodarkening is substantially reduced and nonlinear optical threshold power is substantially increased as compared to a conventional laser. In the apparatus, the rare-earth doped lasing fiber is adapted to include a doping of less than one-half conventional lasing fiber, a corresponding reduction in cladding diameter, and a corresponding reduction in core to cladding diameter ratio. Alternatively in the apparatus, the rare-earth doped lasing fiber has a ratio of effective core area to length at least five times greater than conventional lasing fiber.

In another aspect of the methods and systems described herein an apparatus may include a fiber laser pumped by a wavelength combined high brightness pump that is adapted to substantially reduce heating in a pump/cladding stripper. In the apparatus, the pump may be adapted to provide pump-wavelength stabilization of less than 0.03 nm/C, provide pump-wavelength stabilization of less than 0.01 nm/W, or provide pump-wavelength stabilization of less than 0.03 nm/C and less than 0.1 nm/W.

In another aspect of the methods and systems described herein a QCW laser system including a QCW laser source comprising a plurality of lasers, a wavelength beam combining cavity, comprising the QCW laser source, for producing a wavelength beam combining output, and a coupling facility for coupling the wavelength beam combining output.

In another aspect of the methods and systems described herein a method of cutting steel with a pulsed wavelength beam combining laser may include a laser source comprising a plurality of diode laser, a wavelength beam combining cavity, comprising the plurality of diode lasers, for producing a wavelength beam combined high brightness beam, and a fiber coupling facility for coupling the high brightness beam that is adapted for cutting steel.

In another aspect of the methods and systems described herein a method of spot welding steel with a pulsed wavelength beam combining laser may include a laser source comprising a plurality of diode lasers, a wavelength beam combining cavity, comprising the plurality of diode lasers, for producing a wavelength beam combined high brightness beam, and a fiber coupling facility for coupling the high brightness beam that is adapted for spot welding.

In another aspect of the methods and systems described herein a method of seam welding steel with a pulsed wavelength beam combining laser may include a laser source comprising a plurality of diode lasers, a wavelength beam combining cavity, comprising the plurality of diode lasers, for producing a wavelength beam combined high brightness beam, and a fiber coupling facility for coupling the high brightness beam that is adapted for seam welding.

In another aspect of the methods and systems described herein a method of fine cutting steel with a pulsed wavelength beam combining laser may include a laser source comprising a plurality of diode lasers, a wavelength beam combining cavity, comprising the plurality of diode lasers, for producing a wavelength beam combined high brightness beam, and a fiber coupling facility for coupling the high brightness beam that is adapted for fine cutting.

In another aspect of the methods and systems described herein a method of drilling steel with a pulsed wavelength beam combining laser may include a laser source comprising a plurality of diode lasers, a wavelength beam combining cavity, comprising the plurality of diode lasers, for producing wavelength beam combined high brightness beam, and a fiber coupling facility for coupling the high brightness beam that is adapted for drilling.

In another aspect of the methods and systems described herein a material processing short pulse fiber laser system may include a laser source comprising a plurality of lasers that are capable of short pulse operation, a wavelength beam combining cavity, comprising the plurality of lasers, for producing a high brightness beam that comprises a wavelength beam combining output of the plurality of lasers, and a fiber coupling facility for coupling the high brightness beam that is adapted for materials processing.

In another aspect of the methods and systems described herein a method of pumping a fiber laser may include disposing a first plurality of wavelength beam combining-based lasers proximal to at least a first end of a fiber laser, and delivering optical energy from the pluralities of wavelength beam combining-based lasers to a gain medium of the fiber laser to facilitate outputting increased power and energy from the fiber laser.

In another aspect of the methods and systems described herein a method of pumping a fiber laser may include disposing a wavelength beam combining-based laser proximal to at least a first end of a fiber laser, and delivering optical energy from the wavelength beam combining-based laser to a gain medium of the fiber laser to facilitate outputting increased power and energy from the fiber laser.

In another aspect of the methods and systems described herein an apparatus may comprise a wavelength beam combining pump that is wavelength stabilized by a wavelength beam combining cavity and that has substantially less wavelength thermal dependence than a conventional pump.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts an exemplary wavelength beam combining optical cavity;

FIG. 2 depicts an alternate view along beam combining direction of FIG. 1 with laser smile impact;

FIG. 3 depicts an exemplary embodiment of elements arranged to form a wavelength beam combining laser system;

FIG. 4 depicts a basic architecture of an all-fiber fiber laser and amplifier

FIG. 5a depicts charts of transmission power and transmission loss as a function of NA;

FIG. 6 depicts a chart of photo darkening as a function of ytterbium concentration;

FIG. 7 depicts a chart of pump stripper longitudinal temperature profile;

FIG. 8 depicts a chart of absorption of light energy at various wavelengths for exemplary fiber materials;

FIG. 9 depicts a chart of normalized OSA signal as a function of wavelength for selected power levels;

FIG. 10 depicts an exemplary arrangement of pump lasers for pumping a fiber laser or amplifier;

FIG. 11 depicts an embodiment of multiple WBC pump lasers configured to produce very high power fiber lasers/amplifiers;

FIG. 12 depicts a chart of maximum average power as a function of pulse duration;

FIG. 13 depicts an operational schematic view of a basic architecture for generating a very high peak power amplifier;

FIG. 14 depicts a schematic of a WBC laser system for generating multi-MW peak power fiber amplifiers using a pair of gratings to temporally and spatially overlap the output beams;

FIG. 15 depicts a chart of a short pulse diode laser time domain pulse shape; and

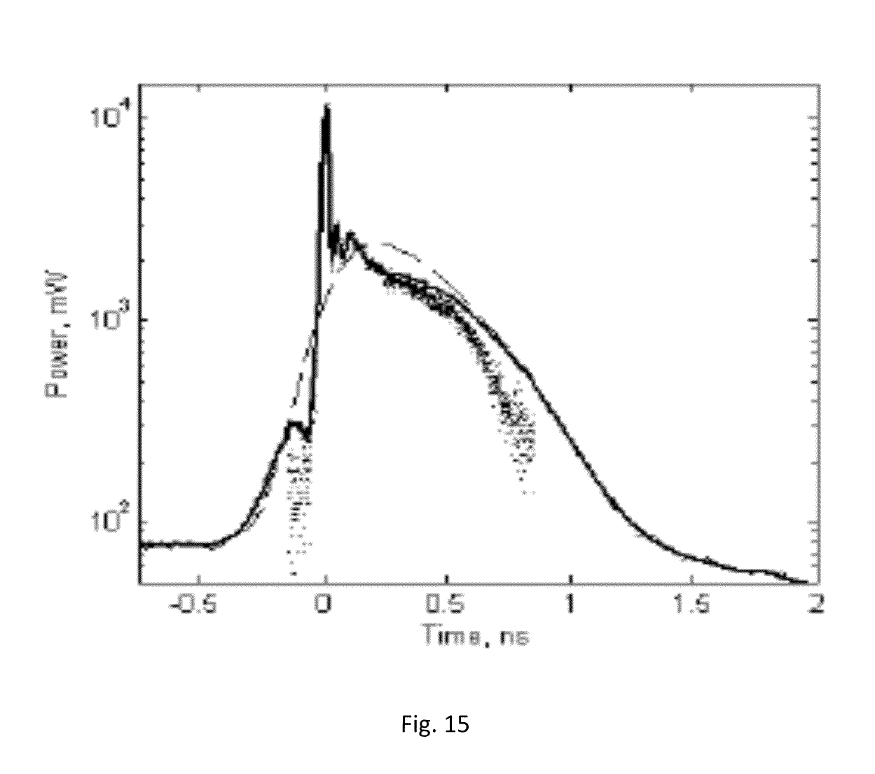

FIG. 16 depicts a WBC-enabled laser for generating arbitrary waveform diode laser pulses.

### DETAILED DESCRIPTION OF THE PREFERRED EMBODIMENT(S)

Wavelength beam combining (WBC) can benefit pump lasers by providing significant benefits over currently available direct pump lasers, fiber lasers, and amplifiers. A WBC pump laser can be used to increase power and/or brightness of a fiber laser or amplifier. Compared to conventional pump lasers, WBC delivers significantly greater power and brightness at pump wavelengths that are more rapidly absorbed by fiber lasers and amplifiers along the fiber length and also maintains a much higher degree of wavelength stability over temperature. However, wavelength beam combined pump lasers offer significant other benefits and advantages that a described herein.

Wavelength beam combining can also benefit pulsed lasers by providing extremely high average and peak output power for short, medium, and long pulse lasers. Wavelength beam combined pump (CW or pulsed) lasers can also dramatically reduce or eliminate factors in fiber lasers that cause substantial compromises in performance, materials, thermal factors, and the like while concerns related to pump brightness, nonlinear optical effects, and physical limitations can be readily overcome when pump lasers are implemented using wavelength beam combining techniques.

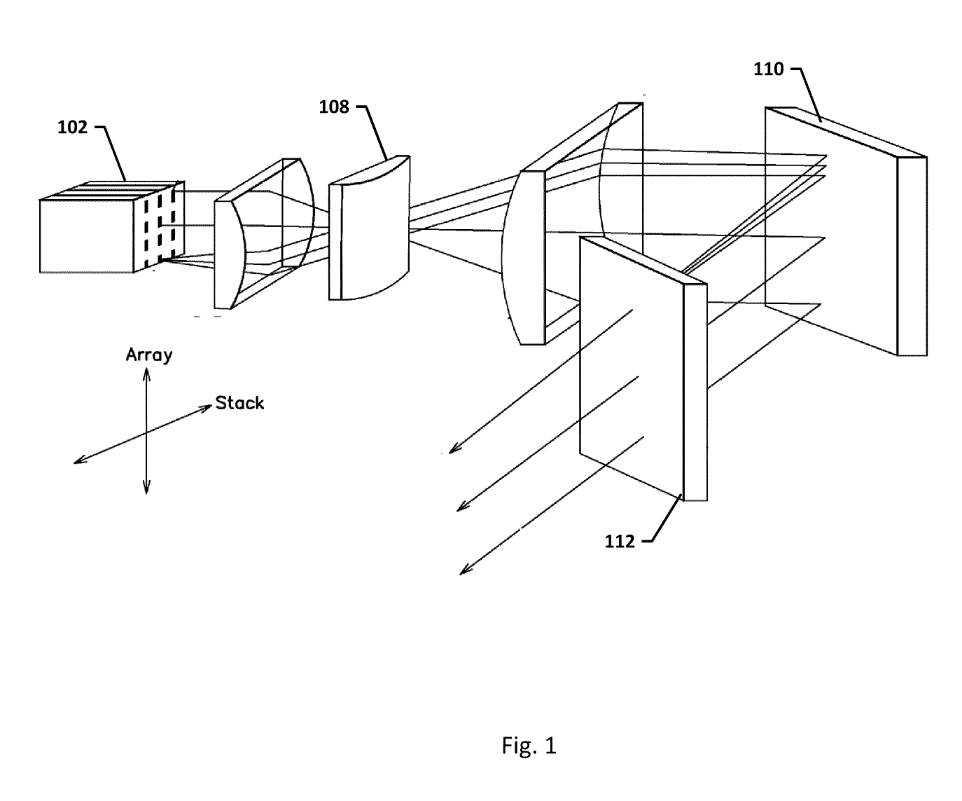

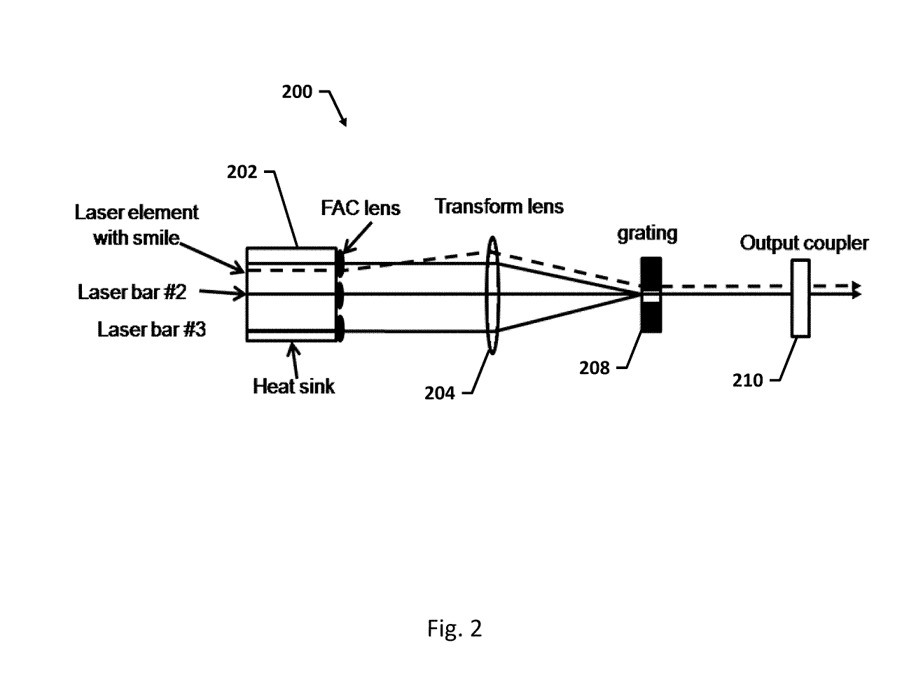

FIG. 1 depicts an exemplary wavelength beam combining optical external cavity 1-D WBC architecture of 2-D laser elements. The cavity consists of 2-D diode laser elements or diode laser stack 102 with fast-axis collimation (FAC) lenses, a cylindrical transform lens/mirror 108, a diffraction element/grating 110 (with dispersion along fast-axis or stack dimension), and a partially reflecting output coupler 112. The transform lens/mirror 108 is placed a focal length from the back-focal plane of the FAC lens 104. The diffraction grating 110 is placed at the focal plane of the transform lens 108. The output coupler 112 is placed on the path of the first-order diffracted beam. As such, ideally, all output beams from the laser elements 102 are spatially overlapped at the grating 110 by the transform lens 108. The reflective output coupler 112 and grating 110 provide feedback for unique wavelength control of the laser elements and overlap the beams in the near field (at the output coupler 112) and the far field. WBC is performed along the stacking dimension of the 2-D diode laser element stack 102. This approach will be referred to as “fast-axis WBC”. The array dimension of the 2-D laser element 102 which is at approximately 90 degrees to the stacking dimension is used for power scaling and not brightness scaling. External-cavity wavelength beam combining operation is independent of laser smile, pointing error, or FAC lens 104 twisting errors as indicated in FIG. 2. To reduce diffraction loss, a cylindrical telescope along the array dimension images each emitter along the array dimension or slow-axis on the output coupler. Along this dimension the cylindrical telescope and diffraction grating are not critical to improved brightness.

FIG. 2 depicts an optical equivalent to FIG. 1 wavelength beam combining (herein WBC) optical cavity 200 along the beam combining (stack) direction. The cylindrical telescope is not shown. The WBC cavity of FIG. 2 includes source diode laser stacks 202, which may be mechanically or optically stacked, or a combination of mechanically and optically stacked. The WBC cavity 200 also includes a transform lens 204, a grating 208, and an optional output coupler 210. After the output coupler 210, a beam shaper, fiber coupling lens and output processing fiber (all not shown) are typically determined based on beam delivery requirements. Alternatively, free-space output is a possible beam delivery option. The dashed line in the FIG. 2 corresponds to laser elements with smile. Elements with smile or collimation errors may not be fully spatially overlapped at the diffraction grating. These elements, however, will still operate in the external cavity due to the function of the grating and output coupler. However, light from the smile-impacted laser element will be somewhat degraded by the output beam coupler. Also, the beam that is output from the beam coupler will have included light from the WBC beam and from the smile-impacted beam. All elements within a given bar including elements with smile will lase at nominally the same wavelength. Since there is a one-to-one correspondence between position and spectrum, this results in some broadening of the beam size after the output coupler. However, the effective feedback for all the elements with smile or collimation errors is essentially 100% and is independent on the amount of smile or any collimation errors.

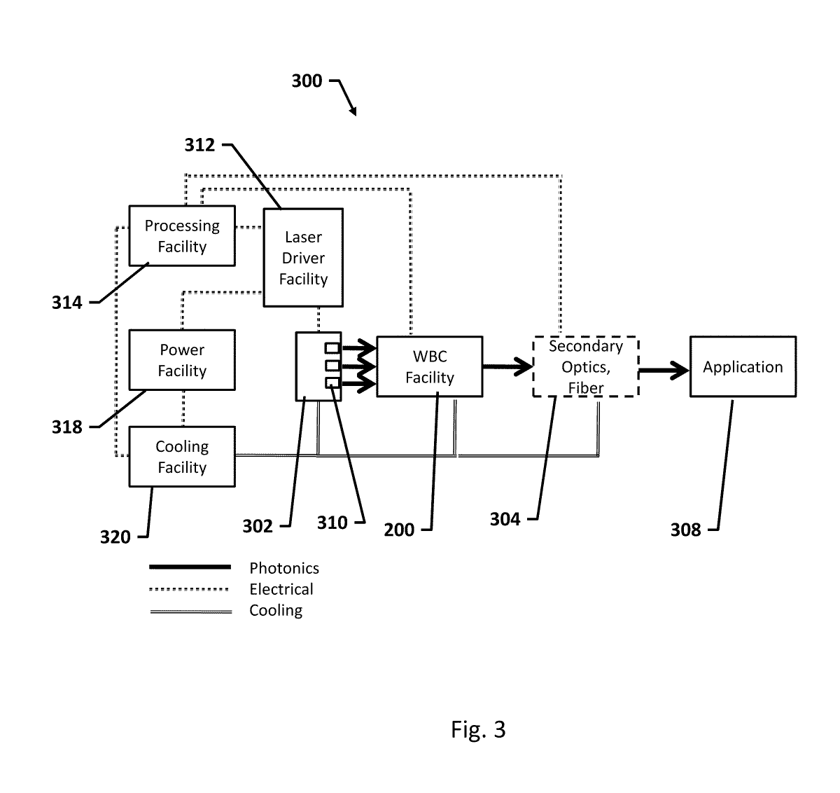

FIG. 3 depicts a laser system 300 in accordance with principles of the present invention. FIG. 3 also depicts several of the internal operation related elements of the laser system 300 along with optional secondary optics and an application environment that may facilitate demonstrating the various elements to be considered in WBC based laser design.

Referring in more detail to FIG. 3, one can see that the laser system 300 includes a multi-dimensional laser array 302 (e.g. at least a two dimensional laser diode array as described herein elsewhere). The multi-dimensional laser array 302 produces several laser beams that are projected into a WBC facility 200, such as the WBC cavity depicted in FIG. 2 for wavelength beam combining. The beam(s) that is emitted from the WBC facility may be directed into secondary optics 304 (e.g. fiber, amplifiers, and the like as described herein and elsewhere). Although the embodiment of FIG. 3 includes secondary optics 304, there are other WBC laser embodiments that do not use secondary optics. In either case, the laser output from the WBC cavity 200 may ultimately be applied to service an application 308. Referring to the internal operations of the laser system, one can see that the multi-dimensional laser array 302 may be operated in conjunction with several other systems. The lasers 310 (e.g. laser diodes) may, for example, be electrically driven from a laser driver facility 312 (e.g. laser diode driver circuit(s). The laser driver facility 312 may take instructions relating to the drive and/or control of the lasers from a processing facility 314 (e.g. a processor, computer, etc.). For example, the processing facility 314 may produce instructions for turning one of more of the lasers 310 on or off or modulate the power in some other way and then the laser driver facility 312 may then follow the instructions by operating one or more of the lasers 310 in accordance with the instructions. A power facility 318 may also be provided to provide power to the laser driver facility 312, which ultimately gets delivered to the lasers 310 once controlled by the laser driver facility 312. Alternatively, in the absence of a laser driver facility 312, the power facility 318 may power the lasers 310 directly. The laser system 300 may also operate with a cooling facility 320. The cooling facility 320 may be used to cool the power facility 318, laser driver facility 312, multi-dimensional laser array 302, WBC facility 200 or other components. In embodiments, the cooling facility 320 may be formed through several separate components and controlled and powered by the processing facility 314 and power facility 318 respectively.

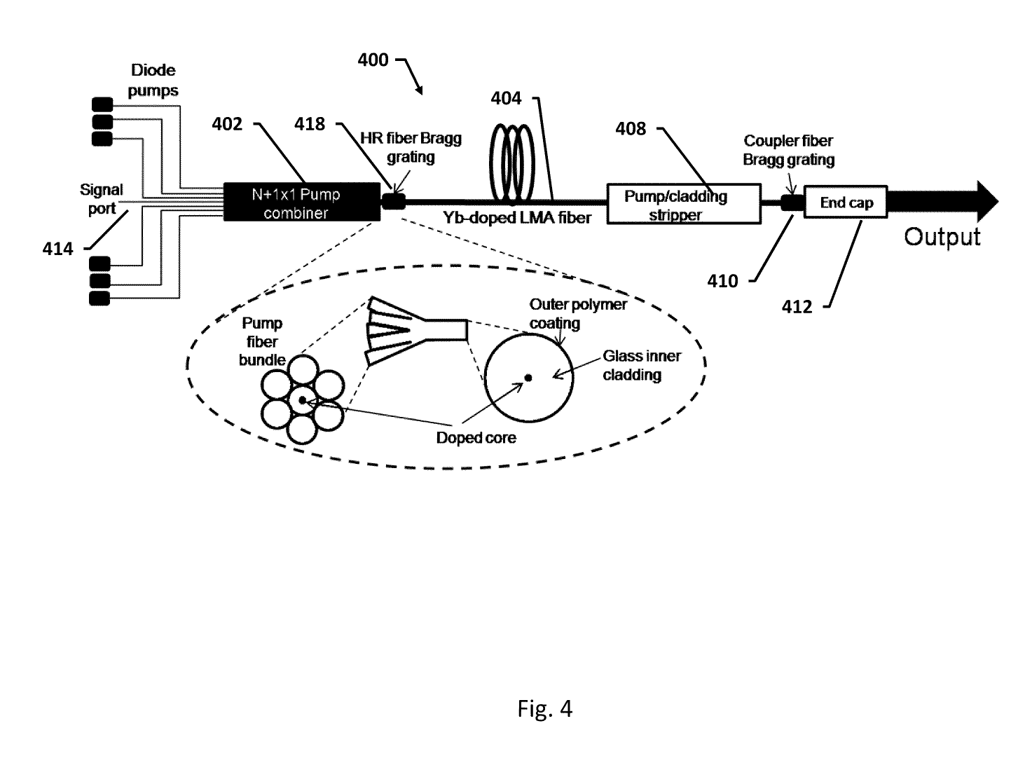

FIG. 4 is an illustration an all-fiber double-clad large-mode-area (LMA) fiber laser or amplifier. The all-fiber LMA laser is configured to operate with no free-space coupling of light. All-fiber may be a preferred approach for high-power fiber laser/amplifier systems. The laser system 400 includes an N+1×1 pump combiner 402, a rare-earth doped double-clad LMA fiber 404, a pump/cladding stripper 408, fiber Bragg gratings 410, and an end cap 412. An amplifier embodiment includes the N+1×1 pump combiner 402, the rare-earth doped double-clad LMA fiber 404, the pump/cladding stripper 408, a signal port 414, and the end cap 412. Note in the amplifier embodiment the fiber Bragg gratings 410 are typically not used and in the laser system embodiment the signal port 414 is typically not used. The end cap 412 is used for protecting the facet of the fiber.

In an N+1×1 pump combiner, N represents the number of diode laser pumps being combined to pump the fiber, +1 refers to a single signal port, and ×1 refers the number of output fibers, which is one in this example. The signal port 414, at left in FIG. 4 can be spliced to a master-oscillator laser source for the amplifier system embodiment, or it can be spliced to a high-reflector fiber Bragg grating 418 as shown.

The inset of FIG. 4 shows in more detail the pump combiner 402 and rare-earth doped double-clad LMA fiber 404. The pump combiner consists, for example as shown, of six (6) pump fibers and a signal fiber. All the fibers are bundled and are fused to the doped double-clad LMA fiber 404. The rare-earth doped LMA fiber 404 consists of a doped core, a glass inner cladding, and an outer cladding/coating with typical diameters 20, 400, and 550 microns, respectively. The outer cladding material is typically a low-index polymer. In operation, a laser signal propagates in the core, which is surrounded by the glass inner cladding in which the pump light propagates. In the example of FIG. 4, only the core is rare-earth doped. The pump light delivered through the pump combiner 402 is restricted to the inner cladding by the outer cladding which has a lower refractive index. A typical numerical aperture of the inner cladding is 0.46. This allows for efficient coupling of highly multimode high-power laser diode pumps. The pump/cladding stripper 408 is a beam dump for any unabsorbed pump light.

Kilo-watt-class diode-pumped fiber lasers and amplifiers have been demonstrated using the scheme in FIG. 4. However, in constructing the system utmost care is needed for reliable operation. Failures in such a laser/amplifier system include burning of the low-index acrylic polymer outer cladding, degradation of the pump combiner due to leakage of the pump light, degradation of the laser output power due to photo-darkening, degradation of the pump/cladding stripper due to excess unabsorbed pump light, and the like. Here we disclose methods and systems based on WBC lasers to mitigate most of these failures. Furthermore, we disclose methods for scaling the system to much higher power and energy. The methods and systems that facilitate mitigating critical failures in high power fiber lasers and amplifiers include: all-glass fiber lasers/amplifiers without the use of acrylic polymers, much lower loss pump combiners using much brighter diode pumps, low doping of the core to avoid photo-darkening, wavelength-stabilized diode pumps to mitigate excess unabsorbed pump light, and the like. We will explore these methods and systems in a variety of exemplary WBC-based laser systems throughout this disclosure.

High average and peak power fiber lasers and amplifiers have numerous industrial, scientific, and defense applications. Industrial applications include metal cutting, welding, and marking. Scientific applications include laser-guide stars for astronomy, gravitational wave detection, laser cooling and trapping, and laser-based particle accelerator. Defense applications include the laser-based weapon, the laser-induced spark, and LIDAR. So far the output power and energy from fiber lasers and amplifiers have yet to reach their full potential. The main limitations for scaling fiber lasers and amplifiers to higher power and higher energy are: 1) pump brightness, 2) nonlinear optical effects (both active and delivery fibers), and 3) physical limitations. The dominant nonlinear optics limitations are stimulated Raman scattering (SRS), stimulated Brillouin scattering (SBS), four wave mixing (FWM), cross phase modulation, and self-focusing. Physical limitations include thermal limitations (extractable power per unit length of fiber), thermal fracture, melting of the fiber core, thermal lensing, and damage limitations at the output facet. While all state-of-the-art fiber lasers and amplifiers are limited by pump brightness. The next most dominant limitation depends on the operation of the lasers and amplifiers (e.g. continuous wave, pulsed, broadband or narrowband, and the like).

As noted above, the state-of-the-art output of fiber lasers or amplifiers is critically limited by the brightness of the pump lasers. The pump-brightness-limited power in a fiber laser is given as

Pₒᵤₜ^{pump}≈≈η_{Laser}Iₚᵤₘₚ(π·b²)·(π·NA²),

where b is the radius of the pump cladding, NA is the numerical aperture of the pump cladding, Iₚᵤₘₚ is the brightness of the pump and is about 0.02 W per μ5 per str, and ηₗₐₛₑᵣ is the optical-to-optical conversion efficiency. The best reported ηₗₐₛₑᵣ optical-to-optical conversion efficiency is about 84%. State-of-art direct diode-pumped fiber lasers and amplifiers are limited to generating kilowatt-class output. Currently, in order to generate higher power, at least two stages of pumping are used. In the first stage, low brightness diode pumps are used to generate kW-class fiber lasers typically operating at 1018 nm. In the second stage, the 1018-nm fiber lasers are used to pump a fiber laser or amplifier to generate the higher output power. One of the main drawbacks is that commonly available Yb-fiber absorption at 1018 nm is as much as a factor of 20 times below that at its 976 nm absorption peak. Thus, in principle, up to a 20 times longer length fiber is needed to efficiently absorb the pump light as compared to a fiber laser that is pumped at 976 nm with the same brightness. As will be shown, WBC-based direct diode pumping with inherently high-brightness sources that can operate at 976 nm result in systems that are less complex (i.e., one, not two stage), lower in cost, higher in efficiency, and produce higher output power than state-of-the-art fiber lasers or amplifiers.

### All-Glass Fiber Laser

Many, high-power fiber lasers and amplifiers may be based on a double cladding geometry which consists of a rare-earth doped silica core, un-doped silica inner cladding, and a low-index acrylic polymer outer cladding as is shown in the insert of FIG. 4. However, as noted above and further describe here, double cladding geometry with low brightness conventional pump lasers has significant drawback for high-power operation.

The laser signal is confined and propagates in the doped silica. The glass cladding acts as a waveguide for the multimode pump beam. Consequently high power pump laser power is present at the polymer-glass interface. The outer polymer cladding has poorer thermal stability than the inner cladding pump area. This portion tends to burn easily or to gradually degrade during fiber laser operation. For example, high optical intensities at the interface can result in damage such as delamination and/or darkening of the acrylic polymer coating which in turn would result in attenuation through absorption or scattering of the pump light. The degradation can also be caused, even at low power operation, by moisture, stress, or absorption of the pump light, particularly in the case of coiled fibers. Coiling of fibers is required to achieve a differential modal loss in order to achieve a near diffraction-limited output beam. Thus, it is a requirement that the glass surface be pristine prior to fiber drawing. This in turn necessitates an ultra-clean manufacturing environment. It is important to note that acrylic polymer cladding is used mainly to achieve the desired high output numerical aperture due to the poor beam quality of the pump diode lasers. The typical numerical aperture is 0.46.

For high power operation an all-glass (glass outer cladding) fiber laser is desirable. Glass has a higher maximum operating temperature, higher damage threshold and higher thermal conductivity than polymer materials. For acrylic polymer cladding the maximum operating temperature is about 80° C. The maximum operating temperature of glass is much higher. The thermal conductivity of silica glass is 1.38 W/(m·K), while that of acrylic polymer is about 0.24 W/(m·K). Thus, all-glass fiber lasers can be more efficiently cooled. However, the numerical aperture of an all-glass fiber is only 0.22. Thus, the requirement on pump laser brightness is at least a factor of four times higher for the all-glass fiber. An ultra-high brightness pump as disclosed herein is at least an order of magnitude brighter than conventional diode pumps which may facilitate switching to an all-glass fiber laser system while enabling a more robust and more reliable system.

### Low-Loss Pump Coupler

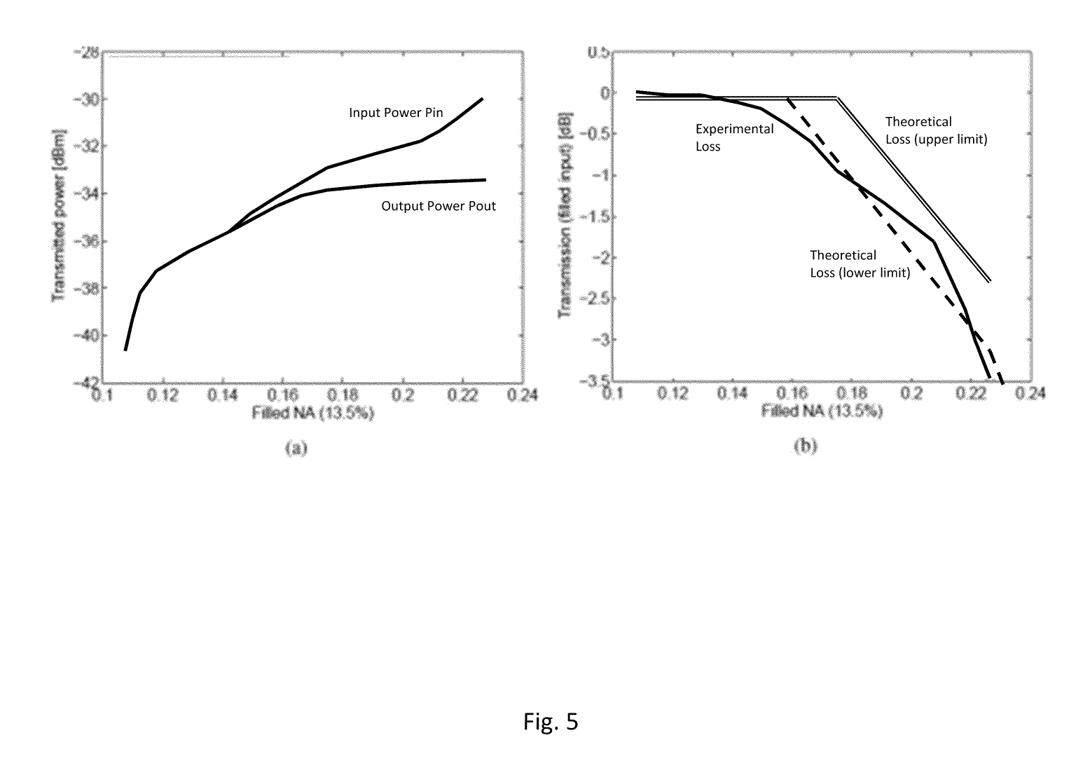

The most common failure mode of a pump combiner results from thermal issues related to coupling the pump(s). As a result of the high power levels passing through a coupler, losses in the coupler will cause the coupler to heat up, particularly at the bond. Excessive heating will cause bond point degradation and additional stress due to the mismatch of expansion coefficients of the packaging materials, ultimately causing the coupler to burn or to melt. Typical state-of-art pump couplers have a loss of approximately several percent. FIG. 5 shows experimental results from ITF Labs, Inc. on a typical loss arising from pump combiners. The chart or FIGS. 5(a) and 5(b) is for a 7×1 pump combiner with 200 μm core, and NA=0.15. The output fiber has 400 μm core and NA=0.22. The left portion of FIG. 5, chart (a) shows the transmitted power for input and output power as a function of input NA. The right portion of FIG. 5, chart (b) shows the loss as a function of the input NA. With a designed input NA of 0.15 the transmission loss is about 0.3 dB, or 6.7% loss. Since 50 W is typically the maximum allowable loss of the combiner before thermal degradation becomes critical, this limits the total input power of the combiner to be 750 W (50 W represents approximately 6.7% of 750 W). Thus, if pumped from both sides with 750 W, such a fiber amplifier will result in approximately 1 kW of output power. As can be seen, due to the limitations of safe pump combiner loss, a much lower loss combiner is required to facilitate scaling to higher output power than even 1 kW. Overcoming the coupler/combiner thermal limitations can be done with at least two paths: better coupler fabrication (which likely comes at a greater cost in materials, handling, and production) and/or much higher brightness pump lasers.

We can use the graph and simplified mathematics to roughly estimate that if the loss is 0.03 dB instead of 0.3 dB then the combiner limit is increased by approximately an order of magnitude to >7000 W. The 5 graph (b) indicates that NA required for such low loss is ˜0.11. As will be shown herein, since a WBC-based ultra-high brightness pump is at least an order of magnitude higher in brightness this NA requirement is easily met. Assuming ten times (10×) higher brightness pump lasers and the same power and fiber diameter (200 μm) the ultra-high brightness pump disclosed herein will have NA of 0.05 which is substantially lower than even the required NA of 0.15. With NA of 0.05 the loss across the coupler is so low that it is essentially zero based on a simplified extrapolation of chart (b). Thus, it appears reasonable to assume that the ultra-high brightness pump disclosed here with 0.03 dB coupler loss will enable a coupler that is capable to handling up to 7,000 W instead of 750 W.

The ultra-high brightness pump disclosed herein could alternatively be used at lower power, such as 750 W so that the loss is about 5 W instead of 50 W. Thus, a more robust and reliable laser system at the same output power is enabled.

### Reduction in Photo-Darkening

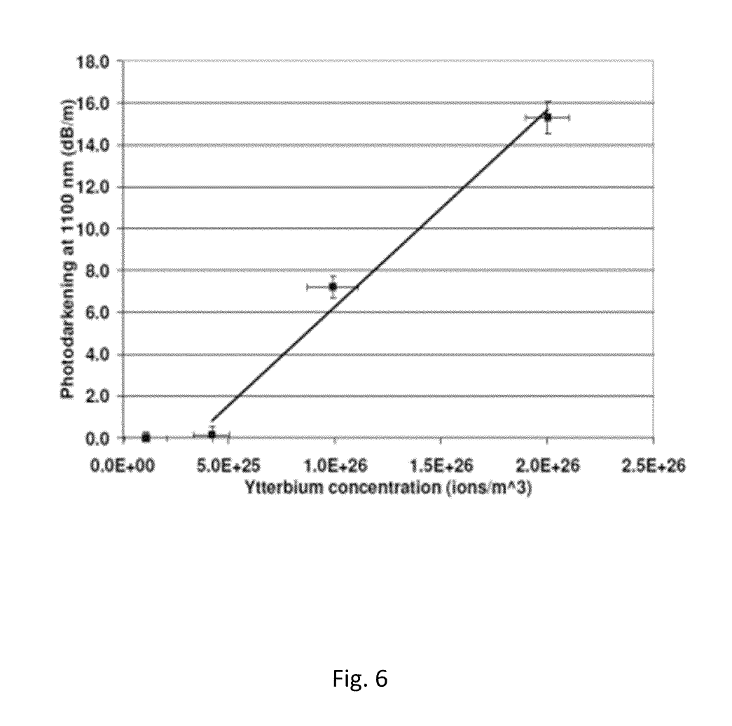

Transparent optical media such as optical fibers and laser crystals can exhibit photo-darkening. When Yb-doped fiber lasers are pumped at 976 nm, clusters of three to four ytterbium ions can absorb pump light and emit radiation in the UV region. The photo-darkening mechanism involves the formation of color centers or other microscopic structural transformations in the medium that is emitting light in the UV region. This will result in absorption or scattering of the desired Yb-laser output light that grows with time. It can lead to serious performance degradation and lifetime reduction. Photo-darkening has been mitigated by two methods: 1) applying aluminum solutions as co-dopant, and 2) lowering the concentration dopant. Lowering the doping level is typically not done since the overlap between the cladding and core is very low. As such, high Yb-doping is required to maintain high pump absorption. A doping level greater than 1×10²⁶ ions/6 is often required. Unfortunately, as the doping level increases in Yb fibers and amplifiers, the photo-darkening effect becomes a problem. In fact, photo-darkening is directly related to the concentration of ytterbium ions as shown in FIG. 6 which shows the photo-darkening at 1100 nm of a 5 μm core fiber laser pumped with 200 mW at 976 nm. The threshold of Yb concentration for avoiding the problems associated with photo-darkening is ˜5×10²⁵ ions/6. While co-doping with aluminum has shown reduction in photo-darkening it adds cost and complexity. The ultra-high brightness diode lasers described herein can be used to lower photo-darkening by enabling use of lower concentration of Yb doping. Since pump light absorption is directly proportional to the doping concentration, lowering the doping level from 2×10²⁶ ions/6 to around 5×10²⁵ ions/6 requires a pump laser source that is at least four times (4×) brighter. A benefit of using higher brightness pump lasers it that with 4× brighter diode laser pumps the inner cladding can be reduced by a factor of two (2×), assuming the same core size. This can be easily explained as follows. The absorption coefficient for pump light in a double-clad fiber laser is proportional to the ratio of the cross-sectional areas of the core and cladding, A_{core} and A_{clad}, and is given by

$${α}_{pump} = {{α}_{core} ( \frac{{D}_{core}}{{D}_{clad}} )}^{2} = {α}_{core} ( \frac{{A}_{core}}{{A}_{clad}} )$$

where D_{core} is the core diameter of the amplifier and D_{clad} is the inner-cladding diameter of the fiber amplifier. αₚᵤₘₚ is the absorption of the pump light and α_{core} is the absorption coefficient in the Yb-doped core. Thus, if doping concentration is lower by four times (4×), the absorption coefficient in the core is four times (4×) lower. This can be compensated by making D_{clad} two times (2×) smaller. Thus, the use of the ultra-high brightness pumps disclosed herein enables the modification of fiber doping and geometry to minimize photo-darkening without reducing fiber laser/amplifier performance. The higher brightness pumps can also be combined with the use of Al co-doped fiber for further enhancement of fiber laser/amplifier performance.

### Robust Pump/Cladding Stripper

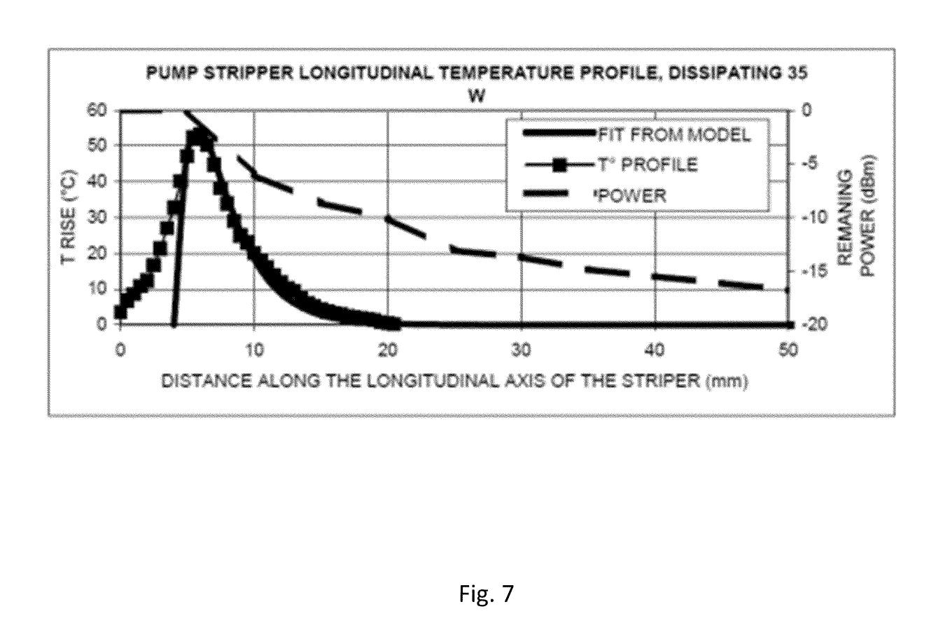

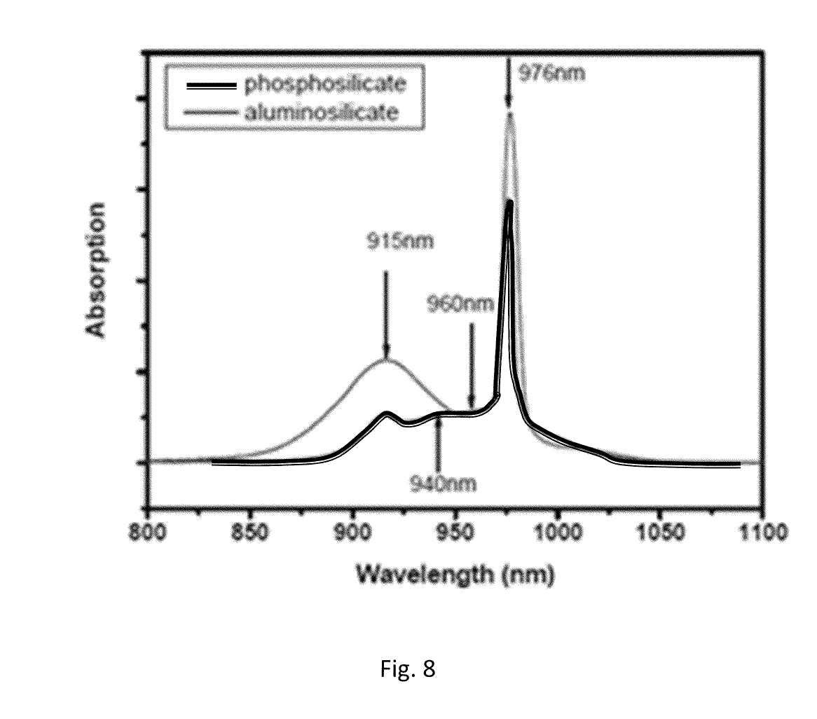

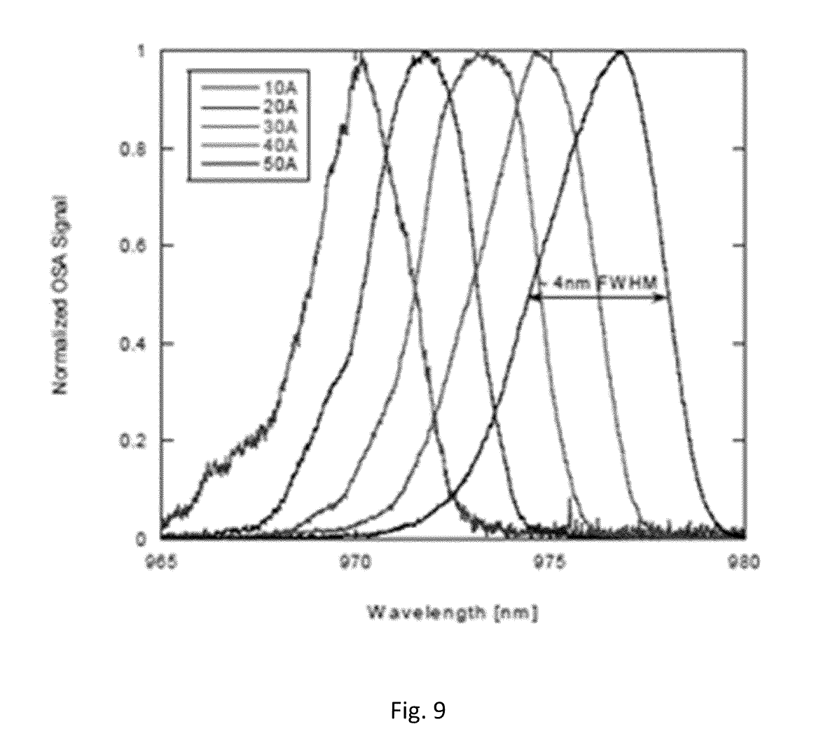

In order to increase the robustness and reliability of all-fiber lasers and amplifiers at high power levels, it is important to properly manage unabsorbed pump light. In typical high-power fiber lasers and amplifiers up to several percent of the pump light is not absorbed. Thus, a kW fiber laser pumped with about 1.5 kW of pump power, up to about 100 W or more is not being absorbed at the full operating power or about 50 W per side if pumped from both sides. In an all-fiber laser system the unabsorbed pump light is being absorbed by the pump/cladding stripper. FIG. 7 shows the temperature rise of about 50 degrees C. of the mode/cladding stripper with 35 W of unabsorbed power from the pump lasers. A temperature rise of 50 degrees C. is probably the maximum allowed. While under steady state operating condition the amount of unabsorbed pump light is manageable in kW-class fiber lasers, under any other operating condition this may not be the case. For example, during the turn-on time the amount of light that is not being absorbed can vary dramatically. FIG. 8 shows the absorption cross section of Yb-doped fiber. In many cases the fiber laser is pumped at 976 nm. However, the absorption bandwidth is narrow and is about 4 to 5 nm. During turn-on time the pump laser wavelength can change by more than the absorption bandwidth of the fiber laser. FIG. 9 shows the typical wavelength shift of a diode laser bars as a function of operating current and power. The wavelength shifts by several nm per 40 A. Current state-of-art diode bars can operate up to nearly 200 A, with 100 A being the most common operating points. Thus, the wavelength shift will be proportionally larger. Thus, a worst case scenario can happen where most of the pump light is not being absorbed. If this were to happen it can destroy the fiber laser. Besides the wavelength shift with respect to power the diode laser wavelength can also shift with respect to temperature. Typical wavelength shift with temperature is about 0.3 nm per degree C. While this is a smaller wavelength shift the diode laser needs to be temperature controlled. The ultra-high brightness pump diode lasers disclosed herein are inherently wavelength stabilized with typical measured center wavelength shifts with respect to temperature and power being <0.002 nm/C and <0.001 nm/W, respectively. This level of wavelength stabilization will lead to a more robust and more reliable high power fiber system, and minimize potential failure due to over-heating of the pump/cladding stripper.

This inherent wavelength stabilization can also lead to faster turn-on and response times for the fiber laser/amplifier to operate at full performance.

### Reduction in Non-Linear Effects

WBC-laser pumps can also benefit fiber lasers and amplifiers that are limited by non-linear effects. These include single-frequency and pulsed fiber lasers and amplifiers. For scaling fiber lasers and amplifiers to much higher power and brightness than is possible to achieve with a single fiber laser or amplifier, laser beam combination is required. There are two methods of laser beam combination: wavelength and coherent beam combination. Both beam combining methods work with single-frequency fiber amplifiers. The main limitation is caused by Stimulated Brillouin Scattering (SBS). Much higher power can be extracted from fiber amplifiers if a higher brightness pump is available. This can be understood as follows. For optical signals whose bandwidth is narrow compared to the Brillouin linewidth (50-100 MHz), the output power of a fiber amplifier is clamped when electrostriction creates an acoustic wave in the fiber leading to back scattering of the signal power (Brillouin scattering). The SBS-limited output power of a fiber amplifier is given by

$${P}_{out}^{SBS} \approx \frac{17 \cdot {A}_{eff}}{{g}_{B} ( Δ v ) {L}_{eff}} ,$$

where g_{B}(Δv)˜5×10⁻¹¹ m/W is the SBS gain coefficient. State-of-art single-frequency diffraction-limited fiber amplifiers are limited to about 100 W. For example, most beam combining experiments performed to date have relied on a single frequency 100-W fiber modules. For a 100-kW system, this requires 1000 fiber modules. Since the ultra-high brightness WBC-laser pumps disclosed herein will be shown to have at least two orders of magnitude higher brightness, it is possible to utilize the enhanced brightness to implement a fiber amplifier design with a factor of 100× enhancement in the A/L ratio, and thereby extract >10 kW of beam-combinable power from a single fiber. Thus a 100-kW system only requires ten (10) fibers. Thus, the diode laser pumps described herein provide the benefits of greatly reduce complexity and cost for 100-kW class applications.

While the inventions, techniques and methods described above are described in general (not specific laser) terms, the data and examples cited are generally for Yb-doped fiber and pumps in the 980 nm range. It is noted here that these inventions, techniques and methods are applicable to other fiber laser and amplifier systems, such as for example, Er-doped fiber sources emitting in the 1550 nm range and pumped in the 1480-1530 nm range, and Tm-doped fiber sources emitting in the 2000 nm range and pumped in the 790 nm range.

Furthermore, the inventions, techniques and methods described herein for enhancing the performance of high-power fiber lasers and amplifiers could in principle be implemented with any other ultra-bright pump source that has been demonstrated (i.e., certain fiber lasers) or that may be demonstrated in the future.

The innovations described herein may be improved examples of a WBC facility as is described in FIG. 3 and may be combined with a wide variety of lasers, laser diodes, laser diode arrays, bars and stacks, WBC techniques, and the like that are generally described herein. While one or more embodiments described herein may include one or more applications of WBC in a fiber pumping arrangement, it should be understood that, the pumping methods and systems described herein may be implemented by any WBC design, including those innovations as referenced herein as well as the various designs described herein and elsewhere in the art.

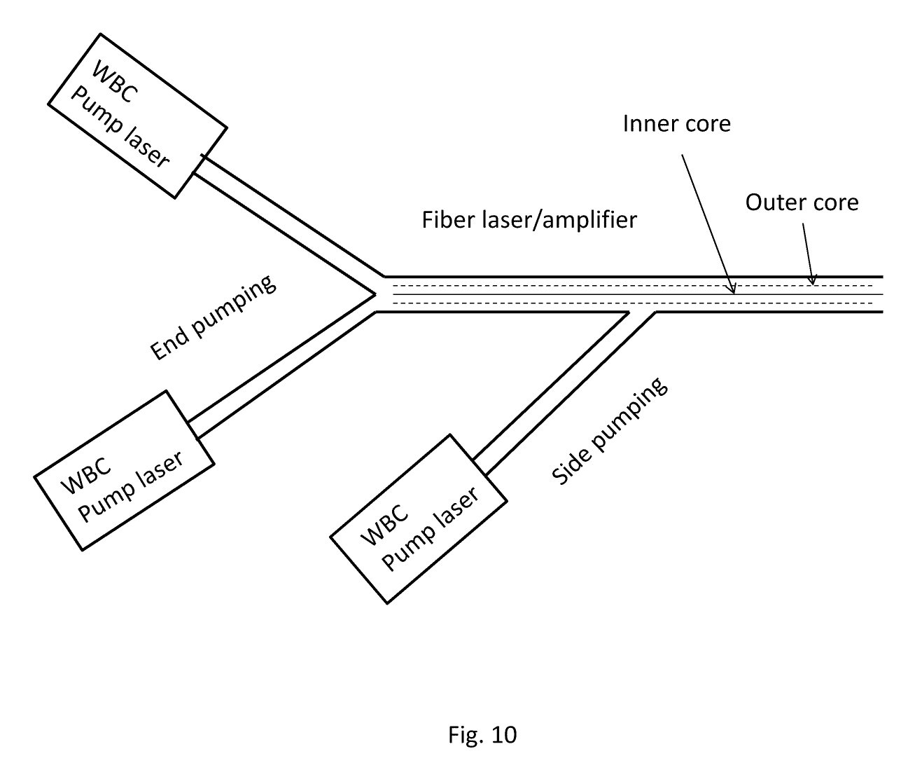

Referring to FIG. 10, which depicts an exemplary arrangement of ultra-high brightness pump lasers for pumping a fiber laser or amplifier, the ultra-high brightness pump lasers can be configured for end pumping and/or side pumping a fiber laser or amplifier. For a dual-clad Fiber, the outer core is pumped by the pump lasers, which pumps the inner core where fiber laser action or amplification occurs. The WBC-based ultra-high brightness pumps describe herein help increase the efficiency and performance of fiber lasers and amplifiers through these and other pump arrangements.

WBC-laser pumps facilitate extracting at least one order of magnitude higher power before the threshold of SRS is reached. This can be understood as follows. In SRS, as the signal power that is propagated through the fiber increases, eventually the power-length product reaches a point where the Raman gain generated by the signal is very high. At this point the signal power is essentially clamped. As the pump power is increased, more and more power is converted to longer, unwanted wavelengths. The peak of the Raman gain is about 13.2 THz lower in frequency. The critical signal power at which backward SRS is significant is given as

$${P}_{out}^{SRS} \approx \frac{16 \cdot {A}_{eff}}{{g}_{R} {L}_{eff}} ,$$

where g_{R} is the Raman gain coefficient (10⁻¹³ m/W for silica), A_{eff} is the effective area of the mode, and L_{eff} is the effective length of the fiber. Using our WBC-laser pumps we can achieve brightness comparable to or higher than the 1018-nm fiber laser pumps. The absorption of our WBC-laser pumps can be up to 20× higher than 1018-nm fiber pumps. Thus, the lengths of our fiber lasers and amplifiers can be at least 20× shorter. And thus from the above equation, we can extract more than 20× higher power before the SRS threshold is reached. Since our scheme is direct diode pumping, our system will be less complex, lower in cost, higher in efficiency, and have a higher output power.

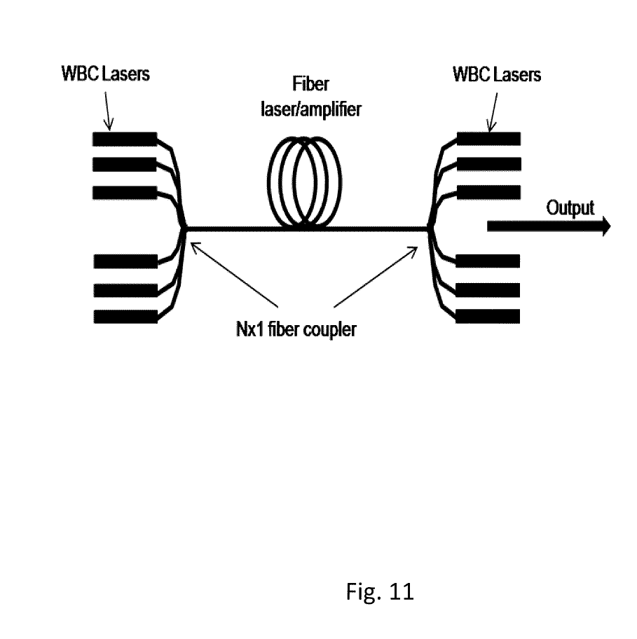

FIG. 11 shows one example of generating very high power fiber lasers/amplifiers using WBC-based lasers. The fiber lasers/amplifiers are pumped from both fiber ends by multiple WBC lasers. As shown in FIG. 11 each fiber end is pumped by 6 WBC lasers using 6:1 fiber combiner. 6:1 fiber combiners are commonly used to generate ˜kW class fiber lasers/amplifiers. Each fiber combiner is typically 105 microns in diameter with a numerical aperture of 0.22. With WBC lasers each producing 1 kW and each fiber combiner handling six pump lasers, a total of 12 kW of pump can be produced to generate a 10 kW fiber laser/amplifier, which is nearly a full order of magnitude greater than non-WBC based pump laser systems.

Another benefit of WBC-laser pumping is that it is wavelength stabilized. Currently, most pumps are not wavelength locked or stabilized. Thus, the performance of the fiber lasers and amplifiers are highly dependent on the operating temperature. This is due to the fact that the wavelength of conventional diode pumps will change with temperature. For example, the useable bandwidth at 976 nm is about 2 to 3 nm. See FIG. 8. As noted earlier, the typical change of wavelength with temperature is about 0.3 nm per degree Celsius. Thus, a 10 degree Celsius change in temperature will result in a shift of 3 nm in operating wavelength of a conventional diode pump. Since after the temperature shift the diode pumps are no longer resonant with the absorption bandwidth of the fiber lasers and amplifiers, most of the pump light is transmitted through the fiber. This can result in catastrophic damage to the fiber lasers and amplifiers. Because WBC-based pumps are wavelength stabilized by design, the shift in operating wavelength with temperature should be reduced by at least an order of magnitude.

Wavelength beam combining, such as fast-axis WBC can be used to produce a very low numerical aperture (NA) pump laser for fiber laser pumping. In particular, very low NA pump lasers based on a diode laser with 976 nm center wavelength may be particularly attractive for their many benefits in delivering a very high brightness pump beam at the preferred pump wavelength for Yb-doped silica fiber lasers with emission wavelength at 1070 nm.

As noted above the advantages of low NA for fiber pumping include increased pump brightness for cladding pumping, which reduces the length of fiber required for the required pump absorption for kW-class fiber lasers and amplifiers. With the reduced NA, it is also possible to make single mode fiber lasers with higher output powers.

As an example, using fast-axis WBC it is possible to construct a pump fiber laser at 976 nm with a spectral bandwidth of 3 nm that is based on diode lasers at a power level of 20 kW (power is limited by the coupling fiber) with a core diameter of 200 microns and a fiber NA of only 0.1. The WBC-based pump laser is unique in that it can generate this type of pump power and pump brightness with very low NA.

Another significant benefit of a high brightness fiber pump with low numerical aperture is that it allows for a drastic reduction in the requirements for a beam dump that is commonly required with fiber lasers to handle non-absorbed pump radiation. Beam dump requirements are drastically reduced when using WBC enabled pump lasers because the non-absorbed pump intensity is reduced considerably due to the higher brightness and other features of a fast-axis WBC pump design.

A WBC enabled brightness fiber pump with low numerical aperture also may simplify and enable the design and construction of narrow bandwidth and single frequency fiber lasers and amplifiers, for example, those that are coherently combinable.

Such a pump laser, using fast axis WBC (fast axis WBC is equivalent to WBC performed along the stacking dimension), inherently has a stable center frequency as a function of temperature and drive current (we noted above that center frequency stability is a benefit inherent in fast axis WBC lasers), which is in contrast to conventional diode laser pumps. This is useful, for example, in allowing for both low power and high power operation of the fiber laser and amplifier. When the drive current applied to the diode laser pump is increased from low current to high current, the center wavelength of the diode laser pump is nearly fixed, so that it always falls within the absorption bandwidth of the fiber laser gain medium. For example, in Yb-doped silica fiber lasers, the absorption bandwidth at 976 nm is approximately 3 nm FWHM and a fast axis WBC pump laser maintains wavelength to a range of 3 nm and often much less. This WBC pump property makes it unnecessary to take precautions, such as a low power pump diverter, which are conventionally used for fiber lasers and amplifiers due to the expected change in wavelength of a conventional diode laser pump as a function of current.

High average and peak power eye-safe Erbium-doped (Er-doped) fiber lasers and amplifiers have numerous industrial, scientific, and defense applications. So far the output power and energy from these fiber lasers and amplifiers have yet to reach their full potential. The main limitations for scaling Er-doped fiber lasers and amplifiers to higher power and higher energy are the same as for other fiber lasers that have already been described: 1) pump brightness, 2) nonlinear optical effects, and 3) physical limitations. Currently there are two main classes of Er-doped fiber lasers and amplifiers. They are Er-doped and Er—Yb-doped fiber lasers and amplifiers. In Er—Yb-doped fiber lasers and amplifier, diode lasers with emission wavelength of approximately 980 nm are used as pump sources. The 980-nm diode lasers pump the Yb-doped ions. In the excited state the Yb ions transfer energy to Er ions. The Er ions lase at around 1550 nm. Up to a few hundred Watts from fiber lasers have been demonstrated using this concept. For Er—Yb the quantum defect is about 40%. Thus, 40% of the pump light is converted to heat. This is a major problem for scaling to higher power. In Er-doped fiber lasers, diode lasers at wavelengths of 980 nm and 1480 nm can be used as pump sources. However, scaling to high power beyond a few Watts is very difficult. The main limitation is the low doping level of Er ions. For example, in Yb-doped fibers, the core absorption can be as high as 600 dB/m, while the Er-doped fiber the absorption is limited to about 50 dB/m. Thus, for the same fiber laser geometry, the Er-doped fiber laser requires at least ten times longer fiber length. This fact makes kW-class fiber lasers from Er-doped fibers not practical. This problem can be solved with a very high brightness pump with a wavelength centered at 1480 nm. Using fast axis WBC technology, lasers with at least an order of magnitude higher brightness than the current state of the art can be obtained. Since the quantum defect is very low, WBC-pumped Er-doped fiber lasers and amplifiers can be scaled to multi-kW power levels.

In addition to enabling significant scaling of Er-doped and Er—Yb-doped fiber laser power levels WBC facilitates the construction of high brightness pump lasers that can be used for other types of eye-safe fiber lasers including thulium and fluoride fiber lasers and amplifiers. For Thulium fiber lasers and amplifiers, pump lasers at 793 nm are required. Fiber-coupled WBC pumps at 793 nm can offer a factor of ten to one hundred times higher brightness as compared with that of conventional fiber-coupled diode lasers.

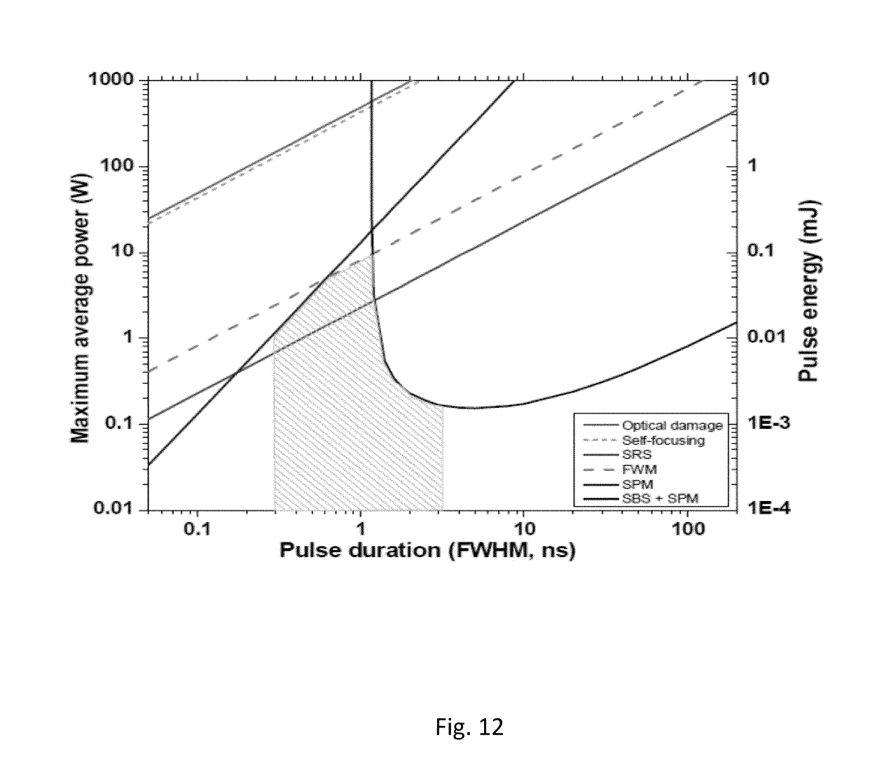

There is also a significant commercial interest in building pulsed fiber laser systems to much higher peak power. However, their performance has yet to approach other solid state lasers. First, due to the small cross-sectional area of a fiber laser core the maximum pulse energy that can be extracted is orders of magnitude smaller than for bulk solid state lasers. A typical single-mode fiber laser or amplifier has a cross-sectional area of less than 400μ5. A typical bulk solid state laser has cross-sectional area much greater than 1 8. Second, due to nonlinearities the output peak power is limited to about one MW or less. Yet despite many recent advances in fiber technologies, nonlinearities in the fiber remain the limiting factor for scaling pulsed fiber amplifiers to higher pulse energy and power. For pulse widths >5 ns, stimulated Brillouin scattering (SBS) is the limiting factor. For pulse widths <0.5 ns, self-phase modulation is the limiting factor and induces a very large distortion of the input spectrum. For ˜1 ns pulses four-wave mixing (FWM) is the limiting factor. FWM leads to broadening of the output spectrum. Since the non-linear effects are proportional to the fiber length, with the ultra-high brightness pumps (e.g. fast axis WBC-based pumps) described herein it should be possible to achieve substantially shorter fiber lengths which should facilitate increasing the extractable output energy proportionally because the non-linear effects are substantially less with shorter fiber lengths. See FIG. 12 that depicts the relationship between output power and nonlinearities of fiber lasers.

High average and peak power fiber lasers and amplifiers have numerous industrial, scientific, and defense applications. Industrial applications include metal cutting, welding, marking, high harmonic generations, and extreme ultra-violet (EUV) generation for lithography. Scientific applications include laser-guide stars for astronomy, gravitational wave detection, laser cooling and trapping, and laser-based particle accelerator. Defense applications include the laser-based weapon, laser-induced plasma channel, and LIDAR. For EUV lithography, one of three remaining risks is lack of EUV sources (resists and masks are the others). The requirements on the EUV source are: wavelength at 13.5 nm, power from 180 to 250 W at intermediate focus, and pulse repetition frequency from 7 to 100 kHz.

There are currently two competing paths to generating the EUV source: discharge produced plasma (DPP) and laser produced plasma (LPP). In an LPP EUV system, EUV light is generated by bombarding tin droplet with a high-power laser. The EUV light is then gathered and focused to produce microchip patterns. The LPP EUV source has potential advantages over the DPP EUV source in terms of debris mitigation, source brightness, and capability of operating at a higher operating rate. These advantages, coupled with recent progress in high power lasers, are increasing the feasibility of LPP-based sources. The source requirements for LPP EUV are: 10 to 20 kW of average power, ns-class pulse width with pulse repetition frequency (PRF) from 7 to 100 kHz (no upper limit to PRF). Currently there are very few lasers can meet these requirements. They tend to be very large, expensive, and inefficient. State-of-art lasers with appropriate pulse width and PRF are limited to be about 7 kW for CO2 lasers and 1500 W for Nd:YAG lasers. Multi-kW fiber laser technology is currently emerging as a potential platform due to its superior compactness, robustness, reliability and efficiency. It has been estimated that the cost of running 10 EUVL sources using a CO2-based laser source with 50% duty cycle and $0.10 per kWh is $4 M per year. Using fiber laser sources, the cost is significantly lower. Consequently, high power pulsed fiber lasers have a significant potential as a cost-effective advantage for high power LPP EUV lithography sources. However, due to a lack of diode laser pump brightness for pumping fiber lasers and non-linear optical effects, the output power from pulsed fiber lasers and amplifiers is significantly lower than what is required for efficient EUV generation.

State-of-the-art fiber lasers with appropriate waveforms are limited to about 50 W. State-of-art CW fiber lasers, however, have been demonstrated up to 10 kW. Here, we disclose methods and systems where very high peak power can be generated from fiber amplifiers. Potentially 10 kW of average power or more can be extracted from a single fiber laser or amplifier with the appropriate waveforms. Extreme high brightness-wavelength-beam-combined pump lasers, wavelength-time-multiplexing of a single fiber amplifier, and wavelength beam combining of multiple wavelength-time-multiplexing fiber amplifiers are disclosed herein that address all the disadvantages of pulsed fiber lasers and amplifiers.

As mentioned earlier for fiber lasers, the main limitations for scaling pulsed fiber lasers and amplifiers to higher energy are: 1) pump brightness, 2) nonlinear optical effects (both active and delivery fibers), and 3) physical limitations. The nonlinear optics limitations are stimulated Raman scattering (SRS), stimulated Brillouin scattering (SBS), four wave mixing (FWM), cross phase modulation, and self-focusing. The physical limitations include thermal limitations (extractable power per unit length of fiber), thermal fracture, melting of fiber core, thermal lensing, and damage limitations at the output facet. All state-of-the-art fiber lasers and amplifiers are limited by pump brightness. If very high brightness pumps are available, the next limitation is non-linear optical effects. For pulsed lasers, the non-linear optical effects depend on the pulse duration. For pulse width >5 ns, stimulated Brillouin scattering (SBS) is the limiting factor. For pulse width <0.5 ns, self-phase modulation induces a very large distortion of the input spectrum. For ˜1 ns pulses four-wave mixing (FWM) and stimulated Raman scattering (SRS) are the limiting factors. For EUV generation, pulse widths in the range of 5 to 10 ns are required and, thus, SBS is the limiting factor.

Wavelength beam combining (WBC) of diode arrays and stacks is an attractive method of achieving the fiber-coupled pump brightness needed to efficiently extract high pulse energy from fiber lasers and amplifiers. As noted earlier, FIG. 2 shows a fast axis WBC architecture that is suitable for increasing the brightness of the pumps by at least one to two orders of magnitude. This much higher pump brightness enables decreasing the length of the fiber lasers and amplifiers by the comparable amount. Since the threshold of SBS is inversely proportional to the length of the fiber, we can also extract more power and energy by the length reduction because SBS becomes less limiting. Current state-of-the-art SBS-limited pulsed fiber amplifiers are limited to about 50 W of average power (operating at a few kHz in PRF and several ns in pulse width). Thus, with WBC-lasers we can expect to extract at least 500 to 5000 W of average power with the same operating parameters. However, even at 5000 W of average power this is still not adequate to efficiently generate EUV light which requires 20 kW or more of power.

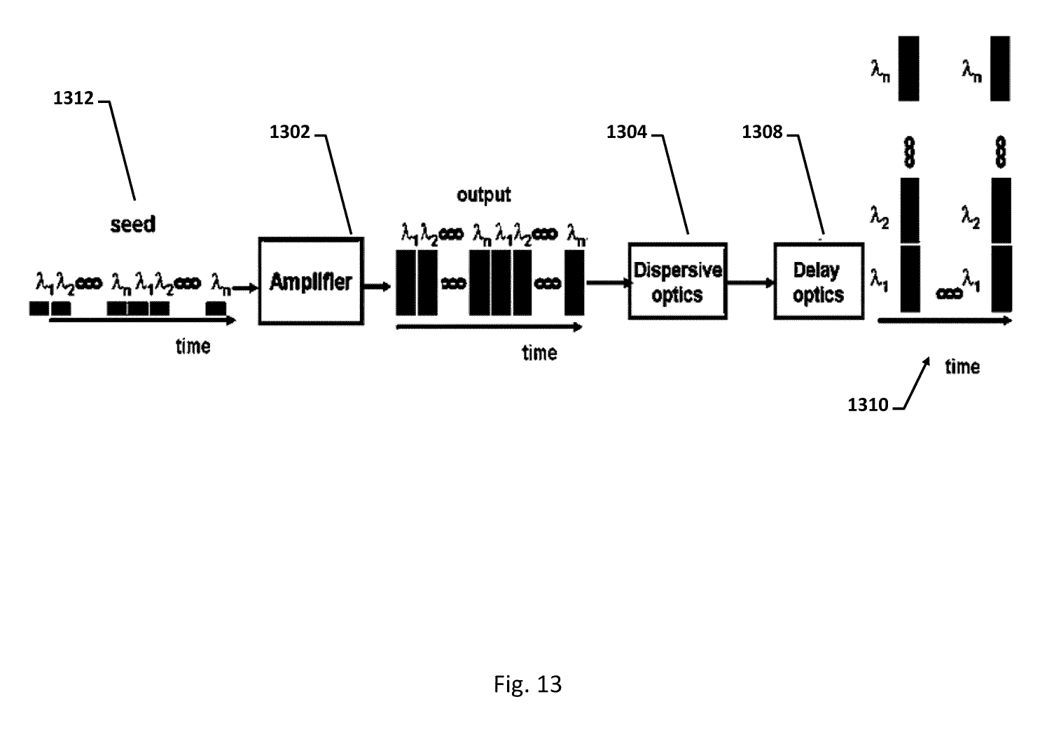

To generate >20 kW of average output power a technique such as that described in U.S. patent application Ser. No. 12/788,579 the entirety of which is incorporated herein by reference may be used. This technique uses time-division-multiplexing of a number of pulsed waveforms, each operating at a slightly different wavelength such that the backward-propagating nonlinear effects (mostly due to SBS) from one wavelength does not interact with any of the other wavelengths. In effect, a nearly continuous waveform is created by filling in the temporal gaps, which enables average power scaling relative to a simple pulsed system by reducing the peak-to-average power ratio, thereby reducing SRS and self-phase modulation (SPM) effects. FIG. 13 shows the concept. A plurality of seed laser beams 1312 are generated with a frequency revisit period that is kept longer than the round-trip time-of-flight through the high-power amplifier 1302 so that two pulses of the same wavelength, as well as any associated backward propagating SBS light, are never in the fiber at the same time. The SBS linewidth for ˜1-μm light is ˜50 MHz so a wavelength spacing of >100 MHz will prevent the different seed frequencies 1312 from interacting through SBS. The use of frequency-hopping waveforms is an important aspect of this technique since frequency hopping not only suppresses SBS, SRS, and SPM; but also of equal importance, interleaving (pulsing) the different wavelengths avoids problems with four-wave-mixing (FWM) and cross-phase-modulation (XPM) that would arise if each wavelength were continuous wave (CW). The output from the amplifier 1302 is then dispersed into its spectral components 1304. Each spectral component is then delayed uniquely 1308. The output from the delay optics 1308 is such that all the spectral components are temporally and spatially overlapped 1310.

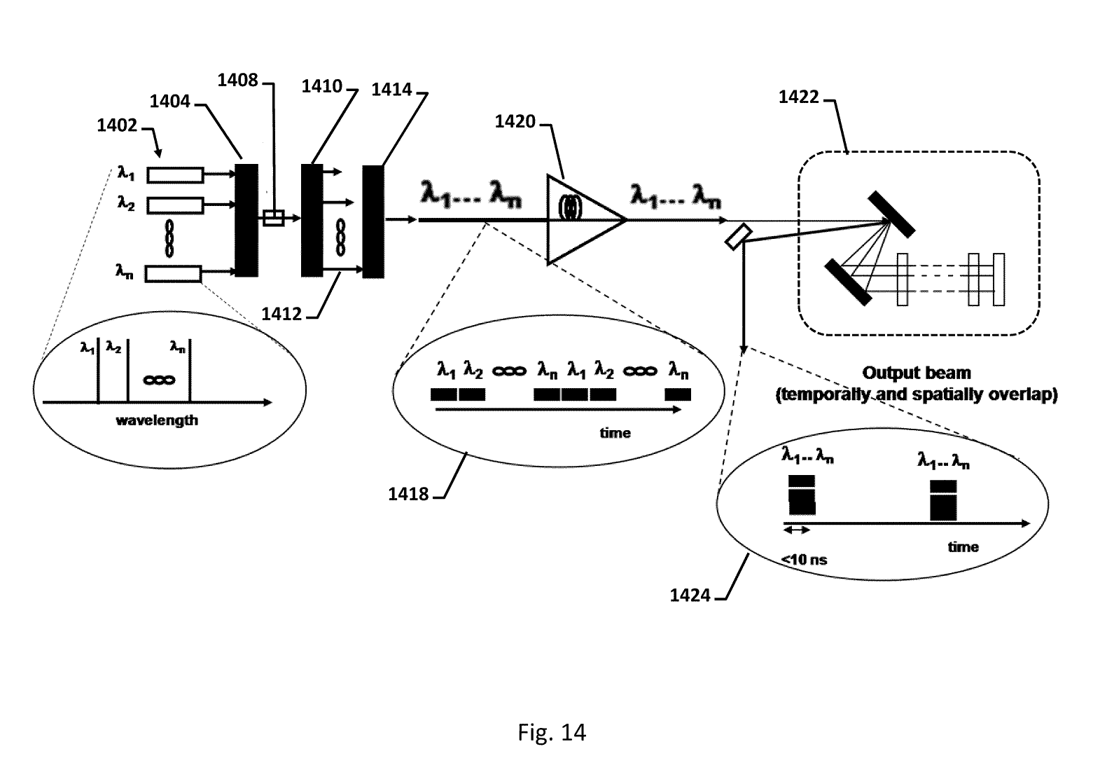

FIG. 14 shows one example implementation. An array of CW low power master oscillators 1402 each at a different wavelength are spatially combined into a single beam by a wavelength division multiplexer (WDM) 1404. Alternatively, the master oscillators can be replaced by a single, mode-locked master oscillator. The output is amplitude modulated by an amplitude modulator 1408. Each wavelength is now operating in pulsed mode. The output is split into its spectral components by a wavelength division de-multiplexer (DMUX) 1410. An array of passive/active fibers 1412 is connected to the DMUX. Each fiber has a unique length. For coherent beam combination phase actuators can be attached to each fiber. The output is spatially multiplexed into a single beam using a second WDM 1414, and the resultant single beam 1418 seeds a WBC-pumped amplifier 1420. To overlap all the beams from all the wavelengths spatially and temporally requires dispersive and delay optics 1422. One example of the dispersive optics and delay optics consists of two gratings (or a transform lens and a grating), a two-mirror beam shaper, and a mirror. The first grating disperses the input beam into its spectral components. The second diffraction grating redirects all the spectral components into parallel beams. The two-mirror beam shaper consists of two parallel mirrors at an angle with respect to the incoming beams. The beam shaper delays each spectral component uniquely. The amount of delay depends on the separation between the mirrors and the angle of incidence. Thus, each spectral component is uniquely delayed and is reflected off of the last minor. The output beam is taken slightly off angle from the incident beam at the first grating. The output beams are now spatially and temporally overlapped with N-times the pulse energy and power, where N is the number of wavelengths 1424. Since the architecture is entirely incoherent, it should be very robust.

Although WBC based pumping of a fiber laser or amplifier can facilitate extracting up to 10 kW CW from a single fiber amplifier prior to non-linear effects in the fiber limiting the output power, practically, 5 kW CW may be the limit for a single wavelength, to stay below the onset of detrimental non-linear effects. Therefore, assuming that 5 kW is the limit then we can propagate two wavelengths through a single fiber amplifier to fully extract 10 kW CW. To generate much more (e.g. >20 kW) of average power based on these WBC enabled power fiber amplifier building blocks, we require an additional technique, wavelength beam combining of multiple fiber amplifiers. There are a few methods of doing wavelength beam combining. The first method is analogous to the cavity shown in FIG. 2. The laser bars and stacks are then replaced with fiber amplifiers. Since the fiber amplifiers are already wavelength stabilized there is no need for the output coupler. The second method uses volume Bragg gratings (VBG). Each VBG is essentially a dichroic minor. The third method uses conventional dichroic mirrors. Since the number of fiber amplifiers required to generate >20 kW is small this method may be the simplest and most cost-effective.

A large market exists for materials processing utilizing short pulsed (pulse widths of a few nanoseconds to hundreds of nanoseconds) operation of industrial lasers. The industrial applications include marking, seam welding, fine cutting, and drilling. The current options for pulsed industrial lasers with brightness suitable for these applications include flash-lamp pumped and diode-pumped Nd:YAG, fiber lasers, and CO2 lasers. Typical parameters for short pulse fiber lasers include 400 ns pulse width, 50 kHz duty cycle, 10 kW peak power, and pulse energy of 4 mJ, and average power in the range of 200 W. There is a large range of laser parameters (for example, pulse widths ranging from the picosecond to nanosecond range) in different laser systems available for different materials processing applications. The conventional lasers in this category are known to require a lot of maintenance, are inefficient, and are expensive.

Herein is described a new type of laser that has significant advantages in cost, efficiency, and simplicity of design over state-of-the-art short pulse industrial lasers. The new type of laser comprises a short pulse direct diode laser in which the outputs of the elements are combined by a form of wavelength beam combination, such as in a WBC cavity. A variety of different source configurations are possible on the source end, including short pulse, gain-switched, bars and stacks which are passively cooled and dense pitch bars and stacks for low cost per Watt. For the WBC cavity, it is possible to use a range of WBC cavities as well as a range of beam combination and brightness enhancing technologies for diode lasers that are disclosed herein and in the patents, publications, and applications referenced herein. We note that although there are many benefits of WBC laser applications for CW operation, as we will describe many additional advantages arise from the transition to short pulse operation.

FIG. 2 shows an example wavelength beam combining (WBC) external cavity that may be used with a short pulse direct diode laser. Diode laser bars and stacks for short pulse operation can be optimized for short pulse operation, as opposed to CW operation. One of the biggest advantages of short pulse operation is that the peak power can be enhanced significantly for each diode laser when operating in short pulse mode as compared with CW mode. This enhancement in peak power comes about because thermal management requirements are reduced drastically when a diode laser is pulse operated.

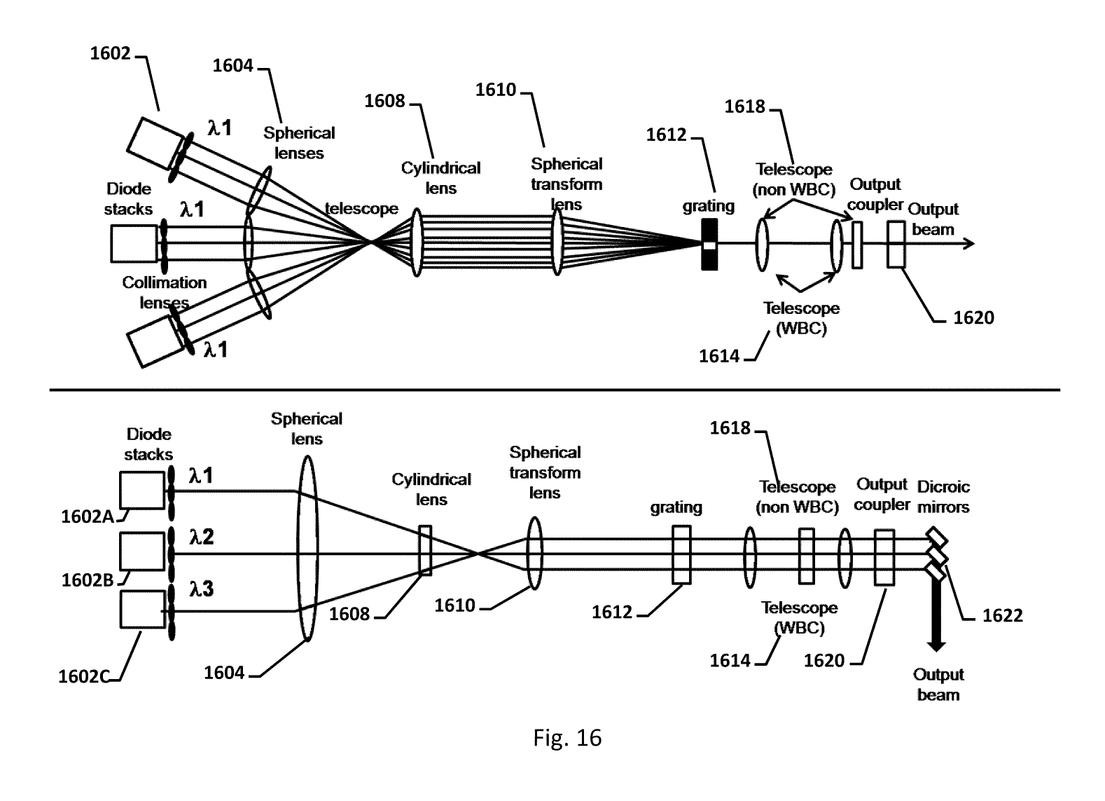

Diode lasers can be gain switched to obtain a peak power that is a factor of nearly eighteen times higher than the CW output power of state-of-the-art diode laser bars. An example of the transient operation of a diode laser is shown in FIG. 16. In the Figure, it can be seen that an initial large transient pulse occurs at the start of the pulse, which allows for the large multiplication factor due to gain switching laser diodes.

The size and style of the package of short pulse stacks can be extremely compact, even in relation to CW stacks, due to the reduced thermal management requirements. Short pulse bars may be passively cooled instead of actively cooled, removing the need for DI water and micro-channel coolers. A pulsed diode laser driver may also be used to provide gain switched diode laser operation for this new type of pulsed laser.

Both the relaxation of the need for micro-channel coolers (which have clogging potential) and a low duty cycle used for operating short pulse bars leads to extremely high diode reliability and increases the simplicity of the laser diodes in the system. Another key advantage to using short pulse bars is that the cost can be very low in terms of cost per Watt of peak power, in part due to the peak power output multiplication factor (10 to 18× is typical as noted above) in the power per bar and in part due to the simplicity of the packaging of short pulse bars. Alternatively, one can use CW diode laser bars and stacks and operate the bars and stacks under CW operation.

More generally, the reduced thermal management requirements of a short pulse laser system simplify thermal management of the entire laser system by lowering the average power being handed by the system while maintaining a high peak power. Low average power allows one to reduce water cooling requirements on key components in the system. For example external elements such as the output fiber following the output coupler and the fiber optical module that brings the beam to the work piece do not require water cooling for low average power.

An example short pulse WBC direct diode laser system can be described as follows. Short pulse diode laser bars with a center wavelength of 940 nm and an output gain-switched peak power of 2000 W per bar may be used as the sources. The laser bars are mechanically stacked in an arrangement allowing for ten (10) bars per stack, resulting in a 20 kW mechanical stack. For 200 kW of total optical peak power, ten (10) such mechanical stacks are needed. These 10 stacks are optically stacked and spatially interleaved, and the optically stacked output beams from all stacks comprise the laser source. The WBC cavity, beam shaper, fiber coupler, and fiber output cable are designed in a manner consistent with that described above for FIG. 2.

The operation parameters of the resultant example laser system are: 1 MHz pulse repetition frequency, 1 ns pulse width, 200 kW peak power, output energy of 0.2 mJ per pulse, and average power of 200 W. The output can easily be coupled to a 400 μm diameter output fiber for materials processing applications. The peak electrical-to-optical efficiency of the laser system is 50% and the system requires very low maintenance and has very high reliability.

In summary, a short pulse direct diode laser system using WBC to combine many short pulse diode lasers may be designed for materials processing applications including marking, spot welding, seam welding, fine cutting, and drilling. This new type of short pulse laser is compact, simple, efficient, and reliable, and the cost is very low.

A large market exists for materials processing utilizing quasi-continuous wave (QCW) or pulsed or long-pulsed operation of industrial lasers. The industrial applications include spot welding, seam welding, fine cutting, and drilling. The current options for QCW industrial lasers with brightness suitable for these applications include flash-lamp pumped Nd:YAG and CO2 lasers. Typical parameters for these lasers include 1 ms pulse width, 10 Hz duty cycle, >10 kW peak power, and pulse energy of >10 J, and average power in the range of >100 W. The conventional lasers in this category are known to require a lot of maintenance, are inefficient (10% wall plug efficiency is typical), and are expensive.

In this disclosure we describe a new type of laser that has significant advantages in cost, efficiency, and simplicity of design over state-of-the-art QCW industrial lasers. This new type of laser comprises a QCW direct diode laser in which the outputs of the elements are combined by a form of wavelength beam combination (WBC). A variety of different source configurations are possible on the source end, including QCW bars and stacks which are passively cooled, continuous wave (CW) bars and stacks for longer pulse width, and dense pitch bars and stacks for low cost per Watt. The wavelength beam combination may be configured with any of the WBC cavities described or referenced herein. FIG. 2 shows an example of a WBC cavity that may be used in this new QCW laser system. We note that although there are many benefits of WBC laser applications for CW operation, as we will describe, many additional advantages arise from the transition to QCW operation.

The diode laser bars and stacks for QCW operation can be optimized for QCW operation, as opposed to CW operation. One of the biggest advantages of QCW operation is that the peak power can be enhanced significantly for each diode laser in the stack when operating in QCW mode as compared with CW mode. This enhancement in peak power comes about in part because thermal management requirements are reduced drastically.

State-of-the-art QCW diode laser bars and stacks are available currently with peak power of 300 W per bar, which is a factor of nearly 4× higher than state-of-the-art CW diode laser bars. For current technology packaged QCW diode lasers bars, the size and style of the package of QCW stacks is extremely compact, even in relation to CW stacks, due to the reduced thermal management requirements. QCW bars are also typically passively cooled instead of actively cooled, removing the need for DI water and micro-channel coolers.

An aspect of this new QCW laser system is a laser diode driver. The laser diode driver determines, to a large extent, the pulse width range that is achievable with a direct diode laser system. The laser diode driver may facilitate direct laser modulation by directly modulating a current that is applied to each of the diode laser sources, or that is, via “direct modulation”. Currently, it is possible to obtain commercial laser diode drivers for bars and stacks of diode lasers that are capable of directly modulating bars and stacks in produce pulse widths that range from tens of nanoseconds to QCW and CW operational regimes (milliseconds to seconds).

Furthermore, in addition to the pulse width, the duty cycle and pulse repetition frequency can be changed over a relatively large range, limited primarily by the capability of the laser diode driver. We note that this feature, of a nearly arbitrary pulsed waveform, may be of particular importance for laser processing applications where, for example, the ability to pulse the laser in specific pulse patterns and repetition frequencies allows one to improve the quality of the laser cutting profile in sheet metal.

Both the relaxation of the need for micro-channel coolers (which have clogging potential) and the low duty cycle used for operating QCW bars leads to extremely high diode reliability and increases the simplicity of the laser diodes in the system. Another key advantage to using QCW bars is that the cost can be very low in terms of cost per Watt of peak power, in part due to the multiplication factor (4×) in the power per bar and in part due to the simplicity of the packaging of QCW bars.

Alternatively, one can use CW diode laser bars and stacks and operate the bars and stacks under CW operation. This may be useful if the application requires longer pulse widths. For example, if a 50 ms pulse width is required, it is preferable to use CW diode laser bars as opposed to QCW diode laser bars, which typically operate in the <10 ms pulse width regime.

More generally, the reduced thermal management requirements of a QCW laser system simplify thermal management of the entire laser system. Low average power allows one to reduce water cooling requirements on key components in the system. For example external elements such as the output fiber following the output coupler and the fiber optical module that brings the beam to the work piece do not require water cooling for low average power.

An example QCW WBC direct diode laser system in accordance to this invention is as follows. QCW diode laser bars with a center wavelength of 940 nm and an output power of 300 W per bar are used as the sources. The laser bars are mechanically stacked in an arrangement allowing for ten (10) bars per stack, resulting in a 3 kW mechanical stack. For 30 kW of total optical peak power, ten (10) such mechanical stacks are needed. These 10 stacks are optically stacked and spatially interleaved, and the optically stacked output beams from all stacks comprise the laser source, such as that shown in FIG. 3. The WBC cavity, beam shaper, fiber coupler, and fiber output cable are designed in a manner consistent with that described above for FIG. 2.

The operation parameters of the resultant example laser system are: 10 Hz pulse repetition frequency, 1 ms pulse width, 30 kW peak power, output energy of 30 J per pulse. The output can easily be coupled to a 400 μm diameter output fiber for materials processing applications. The peak electrical-to-optical efficiency of the laser system is 50% and the system requires very low maintenance and has very high reliability.

It is important to note that the pulse width can also be shortened to the range of 10 to 100 ns using commercial laser drivers by direct modulation of the diode laser sources.

In summary, a QCW direct diode laser system using WBC to combine many QCW diode lasers may be designed for materials processing applications including spot welding, seam welding, fine cutting, and drilling. This new type of QCW laser is compact, simple, efficient, and reliable, and the cost is very low.

A large market exists for materials processing utilizing very high peak power quasi-continuous wave (QCW) or pulsed or long-pulsed operation of industrial lasers. The industrial applications include spot welding, seam welding, fine cutting, drilling, and the like. Typical parameters for these lasers include 0.6 ms pulse width, 1 to 10 Hz pulse repetition rate (or 0.06 to 0.6% duty cycle), >25 kW peak power, and pulse energy of >25 J, and average power in the range of >250 W. There is also a related need for lasers that can generate arbitrary waveforms at these power levels. Currently there are very few lasers that can meet the above specifications and/or waveform requirements. Most industrial laser companies do not offer them. Herein we disclose an arbitrary waveform laser system based on direct diode lasers that can meet or exceed the above parameters. An arbitrary waveform laser system can generate pulses from nanoseconds to continuous wave (CW), with very low repetition rate to continuous wave operation, with peak power from a few Watts to a megawatt or more, and average power from a few milliwatts to tens of kilowatts or more. An arbitrary waveform laser system can be configured to any desired waveform while providing very high output beam quality regardless of the waveform.

An aspect of the technology that may enable an arbitrary waveform laser is 1-D wavelength beam combining of 2-D diode laser stacks. A similar approach could be used for any laser system which can be operated in controllable-pulse mode, and for which several wavelengths of laser operation are possible (e.g., fiber lasers). FIG. 2 shows an exemplary wavelength beam combining (WBC) technology and cavity that may be suitable for the 1-D WBC described herein.

Various diode laser bars and stacks are commercially available. Output power levels up to 200 W CW per bar (e.g. OCLARO Inc.) is commercially available, while 100 W CW per bar is the more typical power level. Output peak power of up to 500 W QCW per bar (e.g. QUANTEL Laser Diodes) is commercially available, while 300 W QCW is the more typical power level. The QCW operating range is up to approximately 3 ms pulse width and up to approximately a 20% duty cycle. These parameters depend on the types of heat sink to which the lasers are mounted. In an example, microchannel-cooler-mounted stacks can operate at up to 20% duty cycle with 0.3 ms pulse width while passively cooled stacks can operate at up to 10% duty cycle with 0.2 ms pulse width and up to 4% duty cycle with 3 ms pulse width. For the following arbitrary waveform design example we will assume that the stacks are passively cooled and operate at up to 3 ms pulse width and up to 4% duty cycle.

FIG. 16 shows one basic cavity for generating arbitrary waveform laser beams with very high power. The top portion of FIG. 16 shows the optical layout along the wavelength beam combining dimension. The bottom portion of FIG. 16 shows the optical layout along the non-wavelength beam combining dimension. In the example embodiment depicted in 16, the laser sources in the cavity consist of a 3×3 set of laser-diode stacks 1602. There are three (3) diode laser stacks 1602 along the wavelength beam combining dimension for each of three distinct wavelengths. Along one wavelength beam combining path, there are three (3) laser stacks 1602, three (3) spherical lenses 1604, a cylindrical lens 1608, a spherical transform lens 1610, a grating 1612, a telescope along the beam combining dimension 1614, a telescope along the non-beam combining dimension 1618, and an output coupler 1620. As indicated in top portion of FIG. 16, all three stacks along the beam combining dimension are nominally at the same wavelength.

Along the non-wavelength beam combining dimension, as shown in bottom portion of FIG. 16, the stacks are nominally at different center wavelengths. In this dimension, the optical components are as shown in the Figure, with dichroic mirrors 1622 for beam shaping. In an example, the top three stacks 1602A are centered at a wavelength of 976 nm, the middle three stacks 1602B are at 915 nm, and bottom three stacks 1602C are at 808 nm. For this example we assume that the focal length of the first spherical lens 1604 arrays is f1=258 mm with diameter D=120 mm. Such a lens has diffraction-limited performance and is available from Special Optics Inc. for a few thousand dollars. The focal length of the cylindrical lens 1608 has a focal length f2=15 mm. The second spherical transform lens 1610 is the same as the first spherical transform lens. The grating 1612 has a groove density of 1660 l/mm. In practice it may be preferable to use a separate grating for each wavelength to fully optimize the efficiency of the gratings. The specific design choice of the telescopes (1614 and 1618) after the grating is not critical. We assume that each stack is composed of 100 bars at 0.85 mm pitch. To achieve this we can use two 50-bar stacks at 1.7 mm pitch and interleave the two stacks to achieve a pitch of 0.85 mm. The aperture of the 100-bar stack is 85 mm along the beam combining dimension and 10 mm along the non-wavelength beam combining dimension. The separation between the stacks along the non-beam combining dimension is less important since each stack is 10 mm wide and the aperture of the first lens is 120 mm. Using the above parameters the spectral linewidth of each center wavelength group is approximately 19 nm. Smaller linewidths are possible by using a longer focal length transform lens. The output will consist of three (3) different wavelength beams. Using dichroic mirrors the three (3) beams can be combined into a single beam.

To generate arbitrary waveform pulses it is desirable to drive each bar with its own driver electronics. In this manner, any combination of pulse length, repetition rate, and peak power can be achieved. If all the nine stacks are driven simultaneously, up to 225 kW peak power can be achieved with up to 3 ms pulse width and 4% duty cycle. If the nine stacks are driven sequentially, for example, to keep the peak power at 25 kW, the duty cycle can be as high as 9×4% or 36%. With 36% duty cycle holes can be drilled 36 times faster than other available industrial lasers. With 0.2 ms pulse width each stack can be driven at a duty cycle of up to 10%. Thus the system can be operated with a duty cycle of up to 90% with 25 kW peak power. For higher output power more stacks can be added.

The example and text above speak to laser pulses of arbitrary desired length and power. It should be noted that with diode lasers, truly arbitrary waveforms (i.e., other than square pulses) can be generated if required for optimum material processing or other application. For example, the initial part of the pulse could be ramped up to an intermediate power level (“pre-heat”), followed by the later part of the pulse being stepped up to a high power level (“soak”). Such waveforms are readily achieved due to the approximately linear relationship between diode laser drive current and power.

1. A short pulse laser system comprising:
a short pulse laser source comprising a plurality of lasers;
a wavelength beam combining cavity, comprising the laser source, for producing a wavelength beam combined output; and
a coupling facility for coupling the wavelength beam combining output.

2. The laser system of claim 1, further comprising a laser driver for modulating the laser source.

3-4. (canceled)

5. The laser system of claim 1, the short pulse laser source produces the light pulses using laser gain switching.

6. The laser system of claim 1, wherein the laser source is a QCW laser.

7. The laser system of claim 1, wherein the laser source is a CW laser operated in a gain-switched pulsed mode.

8-13. (canceled)

14. The laser system of claim 1, wherein the laser source comprises a multidimensional array of diode lasers.

15-16. (canceled)

17. The laser system of claim 1, wherein the plurality of lasers are optically aligned to form an optical stack.

18. The laser system of claim 1, wherein the wavelength beam combining output coupling facilitates coupling to fiber in a 20-600 micron core diameter range.

19-20. (canceled)

21. A system for producing a laser pulse, comprising:
a laser driver capable of direct modulation of a laser source comprising a plurality of lasers; and
a wavelength beam combining cavity, comprising the directly modulated laser source, for producing a wavelength beam combining output of light from the plurality of lasers.

22-23. (canceled)

24. The system of claim 21, wherein the laser source is operated in a gain-switched pulsed mode.

25. The system of claim 21, wherein the laser source comprises a multidimensional array of diode lasers.

26-34. (canceled)

35. The system of claim 21, wherein each of a portion of the plurality of lasers receives a direct modulation signal at a distinct time.

36-37. (canceled)

38. The system of claim 21, further including a coupling facility for coupling the wavelength beam combining output.

39-43. (canceled)

44. The system of claim 21, wherein the laser driver is in communication with the laser source so that each of the plurality of lasers receives a distinct modulation.

45-100. (canceled)

101. A material processing short pulse fiber laser system, comprising:
a laser source comprising a plurality of lasers that are capable of short pulse operation;
a wavelength beam combining cavity, comprising the plurality of lasers, for producing a high brightness beam that comprises a wavelength beam combining output of the plurality of lasers; and
a fiber coupling facility for coupling the high brightness beam that is adapted for materials processing.

102. The laser system of claim 101, further comprising a laser driver for modulating the laser source.

103. The laser system of claim 101, the short pulse laser source produces the light pulses using laser gain switching.

104. The laser system of claim 101, wherein the laser source is a QCW laser.

105. The laser system of claim 101, wherein the laser source is a CW laser operated in a gain-switched pulsed mode.

106. The laser system of claim 101, wherein the laser source comprises a multidimensional array of diode lasers.
